(19) United States
(12) Patent Application Publication
(10) Pub. No.: US 2026/0343033 A1
(43) Pub. Date: Oct. 29, 2026

(54) STREAMING APPARATUS, STREAMING METHOD, AND RECORDING MEDIUM

(71) Applicant: SUNTORY HOLDINGS LIMITED, Osaka City, Osaka (JP)

(72) Inventors: Toshihiko Nonin, Tokyo (JP); Yasuhiro Akama, Tokyo (JP)

(73) Assignee: SUNTORY HOLDINGS LIMITED, Osaka City, Osaka (JP)

(21) Appl. No.: 19/116,003

(22) PCT Filed: Sep. 12, 2023
(86) PCT No.: PCT/JP2023/033239

§ 371 Date: Mar. 27, 2025

(30) Foreign Application Priority Data
Sep. 30, 2022 (JP) 2022-157368

(51) Int. Cl. H04N 21/2187; H04N 21/466; H04N 21/4788

(52) U.S. Cl. CPC H04N 21/2187; H04N 21/4668; H04N 21/4788

(57) ABSTRACT

The present invention solves the problem that it is not possible for users to select and view content out of three or more types of content according to users' preferences, life rhythm, and the like. A streaming apparatus 1 includes: a content receiving unit 124 that receives a first type of content, which is live-streamed content, from a streamer terminal 3; a first streaming unit 142 that streams the first type of content to a user terminal 2; a second streaming unit 143 that streams a second type of content, which is recorded and time-specified content, to the user terminal 2; and a third streaming unit 144 that streams a third type of content that is streamed on demand, to the user terminal 2. Accordingly, it is possible for users to select and view content out of three or more types of content according to users' preferences, life rhythm, and the like.

### TECHNICAL FIELD

The present invention relates to a streaming apparatus and the like capable of streaming content.

### BACKGROUND ART

Conventionally, there have been servers and the like that select and present appropriate workout content information according to the results of user's answers to question information (see Patent Document 1).

### CITATION LIST

### Patent Document

Patent Document 1: Japanese Patent No. 6970480

### SUMMARY OF INVENTION

### Technical Problem

However, according to conventional techniques, it is not possible for users to select, according to users' preferences, life rhythm, and the like, content from among three or more types of content that each employ one streaming method out of three or more content streaming methods, the content including: a first type of content that is live-streamed during a specific time period; a second type of content that is recorded and is streamed during a specific time period; and a third type of content that is recorded and is streamed on demand.

### Solution to Problem

A first aspect of the present invention is directed to a streaming apparatus including: a first receiving unit that receives a first instruction, which is an instruction to stream a first type of content that is transmitted from a streamer terminal of the content, from a user terminal, in a time period that is specified with first streaming time information; a content receiving unit that receives the first type of content transmitted from the streamer terminal, in the time period that is specified with the first streaming time information; a first streaming unit that streams the first type of content received by the content receiving unit to the user terminal from which the first instruction was transmitted, in the time period that is specified with the first streaming time information; a second receiving unit that receives a second instruction, which is an instruction to stream a second type of content that is streamed in a time period that is specified with second streaming time information, from a user terminal; a second streaming unit that acquires the second type of content corresponding to the second instruction received by the second receiving unit and streams the second type of content to the user terminal from which the second instruction was transmitted, at the time that is specified with the second streaming time information corresponding to the second type of content, the second type of content being acquired from a second storage unit in which the second type of content is stored that is associated with the second streaming time information and that is streamed to the user terminal in the time period that is specified with the second streaming time information; a third receiving unit that receives a third instruction, which is an instruction to stream a third type of content that is streamed on demand, from a user terminal; and a third streaming unit that acquires the third type of content corresponding to the third instruction received by the third receiving unit, from a third storage unit in which the third type of content that is streamed on demand is stored, and streams the third type of content to the user terminal from which the third instruction was transmitted.

With this configuration, it is possible for a user to select and view the content according to user's preferences, life rhythm, and the like.

Furthermore, a second aspect of the present invention is directed to the streaming apparatus according to the first aspect, wherein the first receiving unit receives the first instruction from two or more user terminals, the streaming apparatus further includes a user video receiving unit that receives user videos respectively from the two or more user terminals while the first type of content is being streamed, the first streaming unit streams, to each of the two or more user terminals, the user videos of one or more other users among the user videos received by the user video receiving unit, together with the first type of content, the second receiving unit receives the second instruction from two or more user terminals, and the second streaming unit does not stream user videos of one or more other users to each of the two or more user terminals.

With this configuration, it is possible for a user to know or not to know other users' status according to the type of content, and to select and view the content according to user's preferences and the like.

Furthermore, a third aspect of the present invention is directed to the streaming apparatus according to the first aspect, wherein the second receiving unit receives the second instruction from two or more user terminals, the streaming apparatus further includes a user video receiving unit that receives user videos respectively from the two or more user terminals while the second type of content is being streamed, and the second streaming unit streams, to each of the two or more user terminals, the user videos of one or more other users among the user videos received by the user video receiving unit, together with the second type of content.

With this configuration, it is possible to view user videos of other users also when viewing a second type of content, which is recorded content.

Furthermore, a fourth aspect of the present invention is directed to the streaming apparatus according to any one of the first to third aspects, further including: an input information receiving unit that receives, from each of two or more user terminals from which the first type of content, the second type of content, or the third type of content was output, input information input by users regarding the output content; and a statistical processing unit that performs statistical processing on the input information received by the input information receiving unit, thereby acquiring statistical processing results, and outputs the statistical processing results.

With this configuration, it is possible to perform statistical processing based on the input of users regarding three or more types of content, thereby acquiring statistical processing results.

Furthermore, a fifth aspect of the present invention is directed to the streaming apparatus according to the fourth aspect, wherein the input information is associated with a type identifier for identifying the type of the output content, and the statistical processing unit acquires statistical processing results for each of at least three type identifiers, and outputs the statistical processing results for each type identifier.

With this configuration, it is possible to perform statistical processing for each type of content based on the input of users regarding three or more types of content, thereby acquiring statistical processing results.

Furthermore, a sixth aspect of the present invention is directed to the streaming apparatus according to the fourth or fifth aspect, further including: a first reservation receiving unit that receives a first reservation instruction for specifying a viewing reservation for the first type of content, from a user terminal; and a second reservation receiving unit that receives a second reservation instruction for specifying a viewing reservation for the second type of content, from a user terminal, wherein the statistical processing unit acquires statistical processing results regarding viewing reservations for the content, using the first reservation instruction and the second reservation instruction.

With this configuration, it is possible to perform statistical processing based on information on viewing reservations for the content, thereby acquiring statistical processing results.

Furthermore, a seventh aspect of the present invention is directed to the streaming apparatus according to the fourth aspect, further including: a recommendation acquiring unit that acquires recommendation information on content using the statistical processing results; and a recommendation transmitting unit that transmits the recommendation information to a user terminal.

With this configuration, it is possible to perform statistical processing based on the input of users regarding three or more types of content, and to make recommendations to users using the statistical processing results.

Furthermore, an eighth aspect of the present invention is directed to the streaming apparatus according to the seventh aspect, wherein the recommendation acquiring unit refers to a user management unit in which one or more types of user information among viewing history information on content viewed by a user, reservation history information on content reserved for viewing by a user, and input information input by a user are stored in association with a user identifier, and acquires recommendation information on content to be viewed by a user identified with the user identifier.

With this configuration, it is possible to perform statistical processing based on users' viewing history, reservation history, or input information for three or more types of content, and to make recommendations to users using the statistical processing results.

Furthermore, a ninth aspect of the present invention is directed to the streaming apparatus according to any one of the first to eighth aspects, further including: a communication unit that receives communication information from a user of the user terminal and transmits the communication information to the streamer terminal while the first type of content is being streamed.

With this configuration, it is possible to transmit communication information from users to a streamer while the first type of content is being streamed.

Furthermore, a tenth aspect of the present invention is directed to the streaming apparatus according to any one of the first to ninth aspects, further including: a screen instruction receiving unit that receives a screen instruction, which is an instruction associated with a content identifier for identifying a piece of content and is an instruction to output a first-size screen regarding the piece of content, from the user terminal; a screen acquiring unit that acquires screen information for configuring a screen regarding the piece of content corresponding to the screen instruction from a screen storage unit in which the screen information is stored, the screen information being information for configuring the first-size screen, being information for configuring a screen regarding the piece of content, and being information for configuring a screen having a user interface component that is instructed to enable the piece of content to be viewed on a second-size screen, which is larger than the first-size screen; a screen transmitting unit that transmits the screen information acquired by the screen acquiring unit, to the user terminal; and a switching support unit that receives information corresponding to an instruction for the user interface component, from the user terminal, and outputs screen information for configuring the second-size screen corresponding to the information or access information for accessing the screen information.

With this configuration, it is possible to guide users to an environment in which they can easily view the content.

### Advantageous Effects of Invention

With the streaming apparatus according to the present invention, it is possible for a user to select and view the content according to user's preferences, life rhythm, and the like.

### BRIEF DESCRIPTION OF DRAWINGS

FIG. 1 is a conceptual diagram of an information system A in Embodiment 1.

FIG. 2 is a block diagram of the information system A in this embodiment.

FIG. 3 is a block diagram of a streaming apparatus 1 in this embodiment.

FIG. 4 is a flowchart illustrating an operation example of the streaming apparatus 1 in this embodiment.

FIG. 5 is a flowchart illustrating an example of viewing instruction processing in this embodiment.

FIG. 6 is a flowchart illustrating an example of first streaming processing in this embodiment.

FIG. 7 is a flowchart illustrating an example of second streaming processing in this embodiment.

FIG. 8 is a flowchart illustrating an example of statistical processing in this embodiment.

FIG. 9 is a flowchart illustrating an example of recommendation processing in this embodiment.

FIG. 10 is a flowchart illustrating an example of warning processing in this embodiment.

FIG. 11 is a flowchart illustrating an example of viewing end processing in this embodiment.

FIG. 12 is a flowchart illustrating an operation example of a user terminal 2 in this embodiment.

FIG. 13 is a diagram showing a content management table in this embodiment.

FIG. 14 is a diagram showing a user management table in this embodiment.

FIG. 15 is a diagram showing a screen example in this embodiment.

FIG. 16 is a diagram showing a screen example in this embodiment.

FIG. 17 is a diagram showing a screen example in this embodiment.

FIG. 18 is a diagram showing a screen example in this embodiment.

FIG. 19 is a diagram showing a screen example in this embodiment.

FIG. 20 is a diagram showing a screen example in this embodiment.

FIG. 21 is a schematic view of a computer system in this embodiment.

FIG. 22 is a block diagram of the computer system in this embodiment.

### DESCRIPTION OF EMBODIMENT

Hereinafter, an embodiment of a streaming apparatus and the like will be described with reference to the drawings. It should be noted that constituent elements denoted by the same reference numerals in the embodiments perform similar operations, and thus a description thereof may not be repeated.

### Embodiment 1

In this embodiment, an information system including a streaming apparatus that can stream three types of content with different characteristics, that is, a first type of content (which may be said to be live-streamed content), a second type of content, and a third type of content will be described. The first type of content, the second type of content, and the third type of content preferably have video and audio, but may have only video. The first type of content may be said to be live-streamed content. The second type of content may be said to be recorded and time-specified content. The third type of content may be said to be recorded and on-demand content.

Furthermore, in this embodiment, an information system including a streaming apparatus that allows a user terminal to output videos of other viewers while live-streamed content is being viewed on the user terminal and does not allow the user terminal to output videos of other viewers while recorded and time-specified content is being viewed will be described.

Furthermore, in this embodiment, an information system including a streaming apparatus that allows a user terminal to output videos of other viewers while recorded and time-specified content is being viewed on the user terminal will be described.

Furthermore, in this embodiment, an information system including a streaming apparatus that performs statistical processing on input information from viewers will be described. In this embodiment, the streaming apparatus performs statistical processing, for example, for each user, for each type of content, or for each piece of content, thereby acquiring statistical processing results. The streaming apparatus obtains, for example, statistical processing results for viewing reservations through the statistical processing.

Furthermore, in this embodiment, an information system including a streaming apparatus that recommends content to users using the statistical processing results will be described.

Furthermore, in this embodiment, an information system including a streaming apparatus that enables communication between a streamer and a user while live-streamed content is being streamed will be described.

Moreover, in this embodiment, an information system including a streaming apparatus that transmits screen information in which an operation screen with a first size (e.g., a smartphone) has an interface to guide the user to view content on a screen with a second size (e.g., a personal computer, a television, or a projector), which is larger than the first size, will be described.

In this embodiment, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

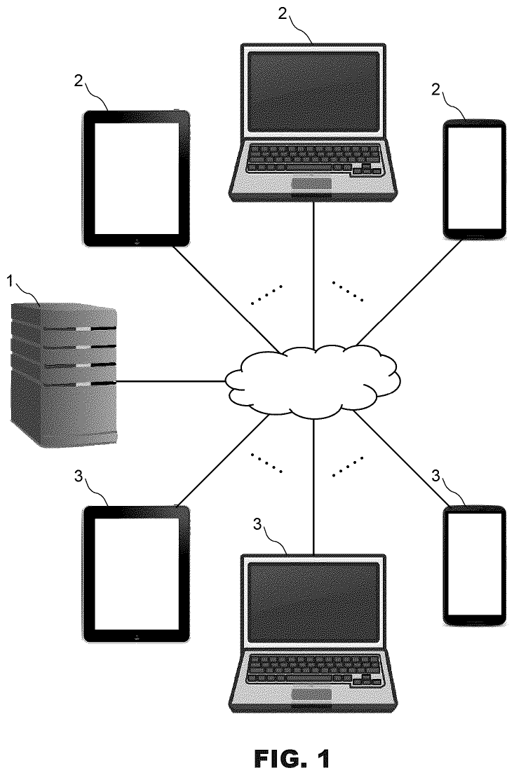

FIG. 1 is a conceptual diagram of an information system A in this embodiment. The information system A includes a streaming apparatus 1, one or two or more user terminals 2, and one or two or more streamer terminals 3.

The streaming apparatus 1 is a server that streams content. The content in this case includes video. The content preferably contains audio. The content is, for example, workout content. The workout content is content to assist users in doing a workout. The workout content is, for example, exercise content, fitness content, stretch content, dance content, yoga content, cardio content, aerobics content, relaxation content, muscle training content, or boxercise content. The content in this case is preferably not content that the user simply watches, but content that enables the user to do some kind of workout.

The streaming apparatus 1 is a so-called server. The streaming apparatus 1 is, for example, a cloud server or an ASP server, but there is no limitation on the type thereof.

The user terminals 2 are terminals that are used by users who view content. The user terminals 2 are, for example, so-called personal computers, smartphones, or tablet devices, but there is no limitation on the type thereof.

The streamer terminals 3 are terminals that are used by streamers. The streamers are people who stream content. The streamers are, for example, people who instruct a workout in workout content. The streamers are, for example, trainers in exercise content, fitness content, stretch content, or the like. The streamer terminals 3 are, for example, so-called personal computers, smartphones, or tablet devices, but there is no limitation on the type thereof.

The streaming apparatus 1 and each of the one or more user terminals 2, and the streaming apparatus 1 and each of the one or more streamer terminals 3 can communicate with each other via a network such as the Internet or a LAN.

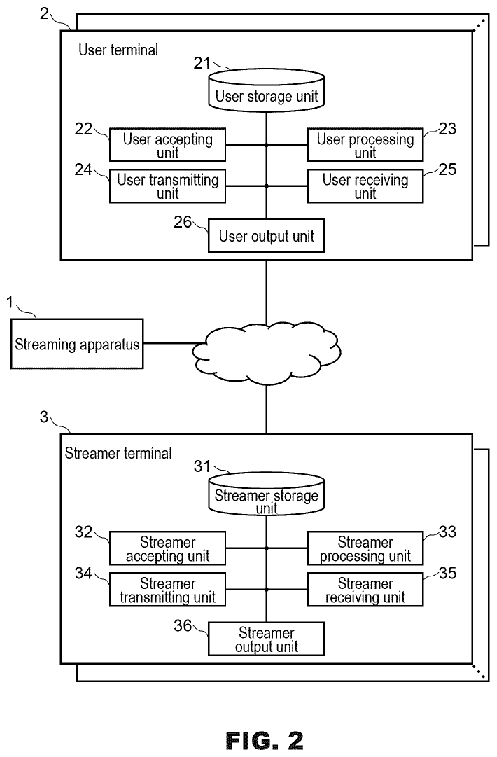

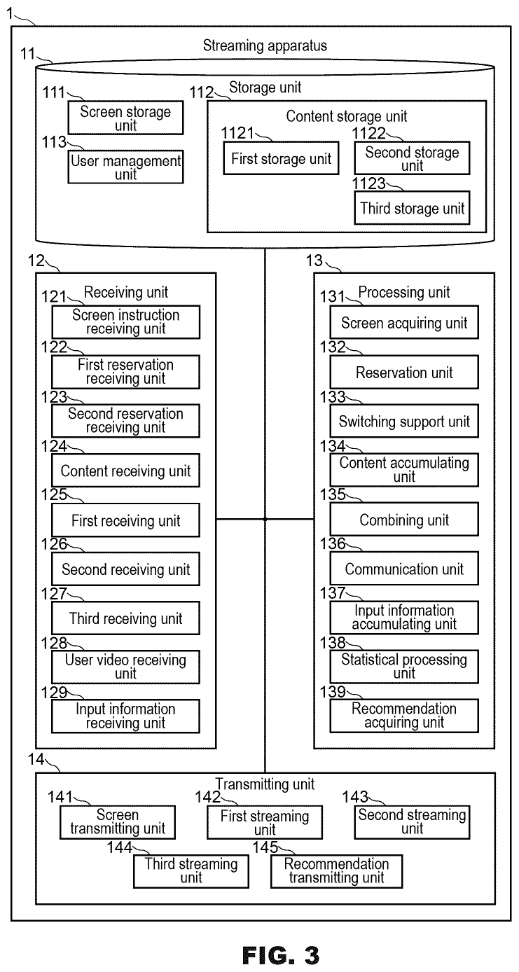

FIG. 2 is a block diagram of the information system A in this embodiment. FIG. 3 is a block diagram of the streaming apparatus 1.

The streaming apparatus 1 includes a storage unit 11, a receiving unit 12, a processing unit 13, and a transmitting unit 14. The storage unit 11 includes a screen storage unit 111, a content storage unit 112, and a user management unit 113. The content storage unit 112 includes a first storage unit 1121, a second storage unit 1122, and a third storage unit 1123. The receiving unit 12 includes a screen instruction receiving unit 121, a first reservation receiving unit 122, a second reservation receiving unit 123, a content receiving unit 124, a first receiving unit 125, a second receiving unit 126, a third receiving unit 127, a user video receiving unit 128, and an input information receiving unit 129. The processing unit 13 includes a screen acquiring unit 131, a reservation unit 132, a switching support unit 133, a content accumulating unit 134, a combining unit 135, a communication unit 136, an input information accumulating unit 137, a statistical processing unit 138, and a recommendation acquiring unit 139. The transmitting unit 14 includes a screen transmitting unit 141, a first streaming unit 142, a second streaming unit 143, a third streaming unit 144, and a recommendation transmitting unit 145.

Each user terminal 2 includes a user storage unit 21, a user accepting unit 22, a user processing unit 23, a user transmitting unit 24, a user receiving unit 25, and a user output unit 26.

Each streamer terminal 3 includes a streamer storage unit 31, a streamer accepting unit 32, a streamer processing unit 33, a streamer transmitting unit 34, a streamer receiving unit 35, and a streamer output unit 36.

Various types of information are stored in the storage unit 11 constituting the streaming apparatus 1. The various types of information are, for example, screen information, three or more types of content, user information, input information, recommendation conditions, one or two or more pieces of schedule information.

The recommendation conditions are conditions for transmitting recommendation information. The recommendation conditions are, for example, that the “number of viewers is the largest and a user has not yet viewed the content” or that the “content has a same attribute value as the content whose satisfaction level of a user is greater than or equal to a threshold value and the user has not yet viewed the content”.

The schedule information is information on a schedule for streaming content. The schedule information has, for example, a content identifier and streaming time information.

The content identifier is information for identifying content. The content identifier is, for example, an ID, a content name, or a URL. The content identifier contained in the schedule information is an identifier of a first type of content or a second type of content.

The streaming time information is information for specifying a time period during which content is streamed. The streaming time information has a streaming start time of content. The streaming time information may have a streaming end time of content. That is to say, the streaming time information may be information for specifying only a streaming start time of content, or information for specifying a streaming start time and a streaming end time.

One or two or more pieces of screen information are stored in the screen storage unit 111. The screen information is, for example, associated with a screen identifier. The screen identifier is information for identifying a screen. The screen identifier is, for example, a URL or an ID.

The screen information is information for configuring a screen that is output to the user terminal 2. The screen information is described, for example, in HTML, XML, or the like, but there is no limitation on the realization method thereof. The screen is, for example, a screen for selecting content to be reserved for viewing, a screen for selecting content to be viewed, or a screen for introducing content.

The screen information is, for example, information for configuring a screen regarding a piece of content. The screen information may be information for configuring a first-size screen, information for configuring a second-size screen, which is larger than the first-size screen, or information for configuring a screen for a tablet.

A user terminal 2 having a first-size screen is, for example, a smartphone or a watch-type terminal, but there is no limitation to these. A user terminal 2 having a second-size screen is, for example, a personal computer, a television, or a projector, but there is no limitation to these.

The screen information is, for example, information for configuring a first-size screen (e.g., a smartphone), is information for configuring a screen regarding a piece of content, and is information for configuring a screen having a specific user interface component.

The specific user interface component is a user interface that is instructed to enable a piece of content to be viewed on a user terminal 2 with the second size such as a personal computer. The user interface component (hereinafter referred to as a “UI component” as appropriate) is a component that constitutes a user interface. The UI component is, for example, an object that is to be selected by a user. The UI component is, for example, a button, a check box, or a menu item. The screen information for configuring a screen having a UI component has component information. The component information is information for configuring a UI component.

Three or more types of content are stored in the content storage unit 112. The content is, for example, a later-described first type of content, a later-described second type of content, and a later-described third type of content.

One or more content attribute values are preferably associated with content. The content attribute values are, for example, a type identifier, a category identifier, a streamer identifier, or a difficulty level identifier. The type identifier is, for example, “second type of content” or “third type of content”.

The category identifier is information for identifying a category of content. The category identifier is, for example, “exercise”, “fitness”, “yoga”, “cardio”, “aerobics”, “relaxation”, “muscle training”, “dance”, “boxercise”, “massage”, or “stretch”.

The streamer identifier is information for identifying a streamer of content. The streamer identifier is, for example, information for identifying a streamer of a first type of content. The streamer identifier is, for example, an ID of the streamer, a name of the streamer, an e-mail address, a telephone number, and an IP address of the streamer terminal 3.

The difficulty level identifier is information for specifying the difficulty level of content. The difficulty level of content is the difficulty level of the workout, or the difficulty level in doing a workout following the content. The difficulty level identifier is, for example, “for beginners”, “for intermediate users”, “for advanced users”, “1”, “2”, “5”, “A”, “B”, or “C”.

The first type of content is stored in the first storage unit 1121. For example, the first type of content that is being streamed is temporarily stored in the first storage unit 1121. For example, the first type of content that was streamed is permanently stored in the first storage unit 1121. The first type of content may be said to be live-streamed content. The streaming time of the first type of content is fixed. It is preferable that the user can communicate with the streamer while the first type of content is being streamed. The user may be said to be a viewer. The type identifier “first type of content” is typically associated with the first type of content.

The first type of content is content that is streamed from the streamer terminal 3 of the content streamer in a time period that is specified with first streaming time information. The first streaming time information is the streaming time information of the first type of content. The first type of content is associated with, for example, a content identifier, a streamer identifier of the content streamer, a type identifier “first type of content”, and first streaming time information. The first type of content corresponds to a later-described first instruction received by the first receiving unit 125, which will be described later.

One or two or more pieces of second type of content are stored in advance in the second storage unit 1122. The second type of content may be said to be recorded and time-specified content. The recorded and time-specified content is content that is recorded and is content that is streamed during a specific time period. Typically, the user cannot communicate with the streamer while the second type of content is being streamed. It is also possible that the users can communicate with each other while the second type of content is being streamed.

The second type of content is content that is streamed to the user terminal 2 in a time period that is specified with second streaming time information. The second streaming time information is second streaming time information of the second type of content. The second type of content is associated with, for example, a content identifier, a streamer identifier of the content streamer, a type identifier “second type of content”, and second streaming time information. The second type of content corresponds to a later-described second instruction received by the second receiving unit 126, which will be described later.

One or two or more pieces of third type of content are stored in advance in the third storage unit 1123. The third type of content may be said to be recorded and on-demand content. The recorded and on-demand content is content that is recorded and is content that is downloaded on demand. The user cannot communicate with the streamer while the third type of content is being streamed. The streaming time of the third type of content is not fixed.

The third type of content is associated with, for example, a content identifier, a streamer identifier of the content streamer, and a type identifier “third type of content”. The third type of content corresponds to a later-described third instruction received by the third receiving unit 127, which will be described later.

It is preferable that the same content is stored as the first type of content, the second type of content, and the third type of content in the storage unit 11.

One or two or more pieces of user information are stored in the user management unit 113. The user information is information on a user. The user information contains one or two or more of viewing history information, reservation history information, and input information. The user information is associated with a user identifier.

The user identifier is information for identifying a user. The user identifier is, for example, a user ID, an e-mail address, or a telephone number.

The viewing history information is information on content viewed by a user. The viewing history information has one or two or more pieces of viewing information. The viewing information is information on content viewed by a user. The viewing information has, for example, a content identifier of content viewed by a user. The viewing information has, for example, viewing time information for specifying when the user viewed the content. The viewing time information may be streaming time information for specifying a time period. The viewing information is typically associated with a user identifier. The viewing history information has, for example, the number of times a piece of content has been viewed.

The reservation history information is information on content reserved for viewing by a user. The viewing reservation is expressed as a reservation as appropriate. The reservation history information has one or two or more pieces of reservation information. The reservation information is information on a viewing reservation for content. The reservation information has, for example, a content identifier of content reserved by the user. The reservation information is typically associated with a user identifier.

The input information is information input by a user. The input information is typically information input by a user regarding content. The input information is, for example, the satisfaction level of viewed content or comments on viewed content. The satisfaction level may be said to be a rating value, a level, or the like.

The receiving unit 12 receives various types of instructions and information. The various types of instructions and information are, for example, later-described screen instructions, later-described first reservation instructions, later-described second reservation instructions, content, later-described first instructions, later-described second instructions, later-described third instructions, later-described user videos, or input information.

The screen instruction receiving unit 121 receives a screen instruction from the user terminal 2. The screen instruction is a request to output screen information. The screen instruction is, for example, an instruction associated with a content identifier for identifying a piece of content, and is an instruction to output a first-size screen regarding a piece of content.

The first reservation receiving unit 122 receives a first reservation instruction from the user terminal 2. The first reservation instruction is an instruction to specify a viewing reservation for the first type of content. The first reservation instruction typically has information for specifying the first type of content. The information for specifying the first type of content is, for example, a content identifier of the first type of content, or streaming time information for specifying a time period during which the first type of content is streamed.

The second reservation receiving unit 123 receives a second reservation instruction from the user terminal 2. The second reservation instruction is an instruction to specify a viewing reservation for the second type of content. The second reservation instruction typically has information for specifying the second type of content. The information for specifying the second type of content is, for example, a content identifier of the second type of content, or streaming time information for specifying a time period during which the second type of content is streamed.

The content receiving unit 124 receives the first type of content transmitted from the streamer terminal 3, in the time period that is specified with the first streaming time information. The content receiving unit 124 typically receives the first type of content from the streamer terminal 3, but may receive the first type of content from an unshown server that received the first type of content from the streamer terminal 3.

The first receiving unit 125 receives a first instruction from the user terminal 2. The first receiving unit 125 preferably receives the first instruction from two or more user terminals 2. The first instruction is an instruction to stream the first type of content. The first instruction typically has information for specifying the first type of content. The first instruction has, for example, a URL, a URI, or a content identifier.

The second receiving unit 126 receives a second instruction from the user terminal 2. The second instruction is an instruction to stream the second type of content. The second instruction typically has information for specifying the second type of content. The second instruction has, for example, a URL, a URI, or a content identifier.

The third receiving unit 127 receives a third instruction from the user terminal 2. The third instruction is an instruction to stream the third type of content. The third instruction typically has information for specifying the third type of content. The third instruction has, for example, a URL, a URI, or a content identifier.

The user video receiving unit 128 receives user videos respectively from the one or two or more user terminals 2 while the first type of content is being streamed. The user terminals 2 in this case are terminals that are outputting the first type of content. The user videos are videos transmitted from the user terminals 2. The user videos are, for example, videos captured by cameras installed in the user terminals 2. The user videos may contain audio. The user videos are typically videos of users who are viewing the content.

The user video receiving unit 128 receives user videos respectively from the one or two or more user terminals 2 while the second type of content is being streamed, for example. The user terminals 2 in this case are terminals that are outputting the second type of content. The user videos are typically videos of users who are viewing the content.

The input information receiving unit 129 receives input information respectively from the two or more user terminals 2 from which the first type of content, the second type of content, or the third type of content was output. The input information is information input by users regarding the output content.

The input information receiving unit 129 typically receives input information associated with a content identifier. The input information is associated with, for example, a type identifier for identifying the type of the output content. The input information is typically associated with a user identifier of a user who input the input information.

The processing unit 13 performs various types of processing. The various types of processing are, for example, processing that is performed by the screen acquiring unit 131, the reservation unit 132, the switching support unit 133, the content accumulating unit 134, the combining unit 135, the communication unit 136, the input information accumulating unit 137, the statistical processing unit 138, and the recommendation acquiring unit 139.

The screen acquiring unit 131 acquires screen information corresponding to the received screen instruction, from the screen storage unit 111. Such screen information is, for example, information for configuring a screen regarding a piece of content, and is information for configuring a first-size screen. Such screen information is, for example, information for configuring a screen having a user interface component that is instructed to enable the piece of content to be viewed on a second-size screen.

The reservation unit 132 performs reservation processing according to a reservation instruction received by the receiving unit 12. The reservation processing is processing that accumulates reservation information in the storage unit 11. The reservation unit 132 accumulates, for example, according to a reservation instruction received by the receiving unit 12, reservation information containing a content identifier corresponding to the reservation instruction, in association with a user identifier of a user who transmitted the reservation instruction. The reservation information is information on a viewing reservation. The reservation information has, for example, a content identifier and a user identifier. The reservation information is, for example, a user identifier associated with a content identifier or a content identifier associated with a user identifier.

For example, if the first reservation receiving unit 122 receives a first reservation instruction, the reservation unit 132 performs reservation processing according to the first reservation instruction. The reservation unit 132 accumulates, for example, reservation information containing a content identifier corresponding to the first reservation instruction, in the user management unit 113, in association with a user identifier of a user who transmitted the reservation instruction. The reservation unit 132 accumulates, for example, reservation information containing a user identification corresponding to the first reservation instruction, in the content storage unit 112, in association with a content identifier corresponding to the first reservation instruction.

For example, if the second reservation receiving unit 123 receives a second reservation instruction, the reservation unit 132 performs reservation processing according to the second reservation instruction. The reservation unit 132 accumulates, for example, reservation information containing a content identifier corresponding to the second reservation instruction, in the user management unit 113, in association with a user identifier of a user who transmitted the reservation instruction. The reservation unit 132 accumulates, for example, reservation information containing a user identification corresponding to the second reservation instruction, in the content storage unit 112, in association with a content identifier corresponding to the second reservation instruction.

The switching support unit 133 receives information corresponding to an instruction for the user interface component, from the user terminal 2, and outputs screen information on a second-size screen of a personal computer or the like corresponding to the information, or access information for accessing the screen information. The access information is, for example, a URL or a URI. The output in this case is, for example, transmission, but it may be accumulation. The accumulation is, for example, accumulation on a web page that is paired with a user identifier, which can later be accessed by a user identified with the user identifier.

For example, if the switching support unit 133 receives information corresponding to an instruction for the UI component, from the user terminal 2, the switching support unit 133 transmits access information for accessing screen information on a second-size screen of a personal computer or the like corresponding to the information, to an e-mail address corresponding to the user terminal 2. The information corresponding to an instruction for the UI component is, for example, a content identifier, a URL, or a UI component identifier.

The content accumulating unit 134 accumulates the content received by the receiving unit 12. The content accumulating unit 134 accumulates, for example, the first type of content received by the first receiving unit 125, in the first storage unit 1121.

The combining unit 135 combines the first type of content received by the first receiving unit 125 and one or two or more user videos. The user videos are videos transmitted from the user terminals 2 and received by the user video receiving unit 128.

The combining the first type of content and one or two or more user videos is configuring a video having the first type of content and the one or more user videos on one screen. The combining unit 135 can be realized by known videoconferencing system technologies or the like, and thus a detailed description thereof has been omitted.

The combining unit 135 combines, for example, the second type of content received by the second receiving unit 126 and one or two or more user videos.

The communication unit 136 receives communication information from a user of the user terminal 2 and transmits the communication information to the streamer terminal 3 while the first type of content is being streamed. With this configuration, it is possible to convey opinions, impressions, and the like of the user who is viewing the first type of content, to the streamer, while the first type of content is being streamed.

For example, the communication unit 136 receives communication information from the streamer of the streamer terminal 3 and transmits the communication information to one or two or more user terminals 2 while the first type of content is being streamed. With this configuration, it is possible to convey opinions, impressions, and the like of the streamer of the first type of content, to users who are viewers, while the first type of content is being streamed.

For example, the communication unit 136 receives communication information from a user of the user terminal 2 and transmits the communication information to the user terminals 2 of other users while the second type of content is being streamed. With this configuration, the communication unit 136 can support communication between users who are viewing the same second type of content.

The communication information is, for example, a text string input by the user, or the user's voice. The communication information may be, for example, a text string input by the streamer.

The input information accumulating unit 137 accumulates the input information received by the input information receiving unit 129. The input information accumulating unit 137 accumulates, for example, the input information received by the input information receiving unit 129, in the user management unit 113, in association with a content identifier corresponding to the input information and a user identifier of a user who transmitted the input information.

The statistical processing unit 138 performs statistical processing on two or more pieces of input information received by the input information receiving unit 129, thereby acquiring statistical processing results, and outputs the statistical processing results. The input information received by the input information receiving unit 129 is, for example, input information of the user management unit 113.

The statistical processing results are a statistical value for each content identifier, a statistical value for each type identifier, or a statistical value for each user identifier.

A statistical value is, for example, a representative value of two or more pieces of input information. A representative value is, for example, a mean or a median. The statistical value is, for example, a representative value of the satisfaction level constituted by two or more pieces of input information. The statistical value is, for example, the number of reservations, the number of reservations in a unit period, a representative value of the number of reservations, the number of views, the number of views in a unit period, a representative value of the number of views, or the percentage of reservations made but not viewed. The number of reservations is the number of pieces of reserved content. The number of views is the number of pieces of viewed content or the number of users who viewed the content.

The statistical processing unit 138 acquires, for example, statistical processing results for each of at least three type identifiers, and outputs the statistical processing results for each type identifier.

The statistical processing unit 138 acquires statistical processing results regarding viewing reservations for the content, using the first reservation instruction and the second reservation instruction. The statistical processing unit 138 acquires the percentage of reservations made but not viewed, for each content identifier or for each type identifier, using the first reservation instruction and the second reservation instruction. The statistical processing unit 138 acquires statistical processing results regarding the number of views of the content.

The recommendation acquiring unit 139 acquires recommendation information on content using the statistical processing results acquired by the statistical processing unit 138. The recommendation acquiring unit 139 refers to the user management unit 113, and acquires recommendation information on content to be viewed by a user identified with the user identifier.

The recommendation acquiring unit 139 preferably acquires recommendation information using the user's viewing history information or reservation history information.

The recommendation information is information on the content to be recommended to the user. The recommendation information contains, for example, information for specifying the content to be recommended to the user. The recommendation information contains, for example, one or two or more content identifiers.

The recommendation information is, for example, information on content whose similarity to the content viewed by the user is greater than or equal to a threshold value and that is streamed on a different day of the week from or at the same time as the viewed content. The recommendation information is, for example, information on content whose similarity to the content viewed by the user is greater than or equal to a threshold value and that the user has not yet viewed.

The transmitting unit 14 transmits various types of information. The various types of information are, for example, screen information, various types of content, or recommendation information.

The screen transmitting unit 141 transmits the screen information acquired by the screen acquiring unit 131, to the user terminal 2.

The first streaming unit 142 streams the first type of content received by the content receiving unit 124 to the user terminal 2 from which the first instruction was transmitted, in the time period that is specified with the first streaming time information.

The first streaming unit 142 preferably streams, to each of the two or more user terminals, the user videos of one or more other users among the user videos received by the user video receiving unit 128, together with the first type of content. The other users are users who are not the user of the user terminal 2 to which the user videos are transmitted. The other users are other users who are viewing the same content as the user of the user terminal 2 to which the user videos are transmitted.

The second streaming unit 143 acquires the second type of content corresponding to the second streaming time information from the second storage unit 1122 and streams the acquired second type of content to the user terminal 2 from which the second instruction was transmitted, at the time that is specified with the second streaming time information.

The second streaming unit 143 preferably does not stream user videos of one or more other users to each of the two or more user terminals 2. The not streaming user videos of one or more other users means that user videos are not streamed to the user terminals 2 in the case in which the second type of content is streamed.

The second streaming unit 143 may stream, to each of the two or more user terminals 2, the user videos of one or more other users among the user videos received by the user video receiving unit 128, together with the second type of content.

The third streaming unit 144 acquires the third type of content corresponding to the third instruction received by the third receiving unit 127, from the third storage unit 1123, and streams the third type of content to the user terminal 2 from which the third instruction was transmitted.

The recommendation transmitting unit 145 transmits the recommendation information acquired by the recommendation acquiring unit 139, to the user terminal 2.

Various types of information are stored in the user storage unit 21 constituting the user terminal 2. The various types of information are, for example, a user identifier.

The user accepting unit 22 accepts various types of instructions and information. The various types of information, instructions, and the like are, for example, input information, communication information, first instructions, second instructions, third instructions, first reservation instructions, second reservation instructions, or screen instructions.

The various types of information, instructions, and the like may be input by any input part such as a touch screen, a keyboard, a mouse, or a menu screen.

The user processing unit 23 performs various types of processing. The various types of processing are, for example, processing that changes the accepted information, instructions, and the like into information, instructions, and the like with a structure for transmission. The various types of processing are, for example, processing that changes the received information into information with a structure for output.

The user transmitting unit 24 transmits various types of information, instructions, and the like to the streaming apparatus 1. The various types of information, instructions, and the like are, for example, input information, communication information, first instructions, second instructions, third instructions, first reservation instructions, second reservation instructions, or screen instructions.

The user receiving unit 25 receives various types of information from the streaming apparatus 1. The various types of information are, for example, various types of content, user videos of other users, or statistical processing results.

The user output unit 26 outputs various types of information. The various types of information are, for example, various types of screens, various types of content, user videos of other users, or statistical processing results.

The output in this case is typically display on a display screen or projection using a projector, but it may be a concept that encompasses printing by a printer, output of a sound, transmission to an external apparatus, accumulation in a recording medium, and delivery of a processing result to another processing apparatus or another program.

Various types of information are stored in the streamer storage unit 31 constituting the streamer terminal 3. The various types of information are, for example, a streamer identifier.

The streamer accepting unit 32 accepts various types of instructions and information. The various types of information, instructions, and the like are, for example, content or communication information.

The streamer accepting unit 32 includes a camera, for example, and captures, for example, video of a streamer who is doing a workout, thereby acquiring a first type of content. The streamer accepting unit 32 includes a microphone, for example, and acquires the streamer's voice. It is preferable that the first type of content has not only video but also audio.

The streamer processing unit 33 performs various types of processing. The various types of processing are, for example, processing that changes the accepted information, instructions, and the like into information, instructions, and the like with a structure for transmission. The various types of processing are, for example, processing that changes the received information into information with a structure for output.

The streamer transmitting unit 34 transmits various types of information, instructions, and the like to the streaming apparatus 1. The various types of information, instructions, and the like are, for example, content or communication information.

The streamer receiving unit 35 receives various types of information from the streaming apparatus 1. The various types of information are, for example, user videos of one or two or more users, input information, or statistical processing results.

The streamer output unit 36 outputs various types of information. The various types of information are, for example, user videos of one or more users, input information, or statistical processing results.

The output in this case is typically display on a display screen or projection using a projector, but it may be a concept that encompasses printing by a printer, output of a sound, transmission to an external apparatus, accumulation in a recording medium, and delivery of a processing result to another processing apparatus or another program.

The storage unit 11, the screen storage unit 111, the content storage unit 112, the user management unit 113, the input information management unit 114, the first storage unit 1121, the second storage unit 1122, the third storage unit 1123, the user storage unit 21, and the streamer storage unit 31 are preferably non-volatile recording media, but they may alternately be realized by volatile recording media.

There is no limitation on the procedure in which information is stored in the storage unit 11 and the like. For example, information may be stored in the storage unit 11 and the like via a recording medium, information transmitted via a communication line or the like may be stored in the storage unit 11 and the like, or information input via an input device may be stored in the storage unit 11 and the like.

The receiving unit 12, the screen instruction receiving unit 121, the first reservation receiving unit 122, the second reservation receiving unit 123, the content receiving unit 124, the first receiving unit 125, the second receiving unit 126, the third receiving unit 127, the user video receiving unit 128, the input information receiving unit 129, the user receiving unit 25, and the streamer receiving unit 35 are typically realized by wireless or wired communication parts, but they may also be realized by broadcast receiving parts.

The processing unit 13, the screen acquiring unit 131, the reservation unit 132, the switching support unit 133, the content accumulating unit 134, the combining unit 135, the communication unit 136, the input information accumulating unit 137, the statistical processing unit 138, the recommendation acquiring unit 139, the user processing unit 23, and the streamer processing unit 33 may be typically realized by processors, memories, or the like. Typically, the processing procedure of the processing unit 13 and the like is realized by software, and the software is stored in a recording medium such as a ROM. However, the processing procedure may be realized by hardware (dedicated circuits). The processors are, for example, CPUs, MPUs, GPUs, or the like, but there is no limitation on the type thereof.

The transmitting unit 14, the screen transmitting unit 141, the first streaming unit 142, the second streaming unit 143, the third streaming unit 144, the recommendation transmitting unit 145, the user transmitting unit 24, and the streamer transmitting unit 34 are typically realized by wireless or wired communication parts, but they may also be realized by broadcasting parts.

The user accepting unit 22 and the streamer accepting unit 32 may be realized by a device driver for an input part such as a touch screen or a keyboard, control software for a menu screen, or the like.

The user output unit 26 and the streamer output unit 36 may be considered to include or to not include an output device such as a display screen or a speaker. The user output unit 26 and the like may be realized by driver software for an output device, a combination of driver software for an output device and the output device, or the like.

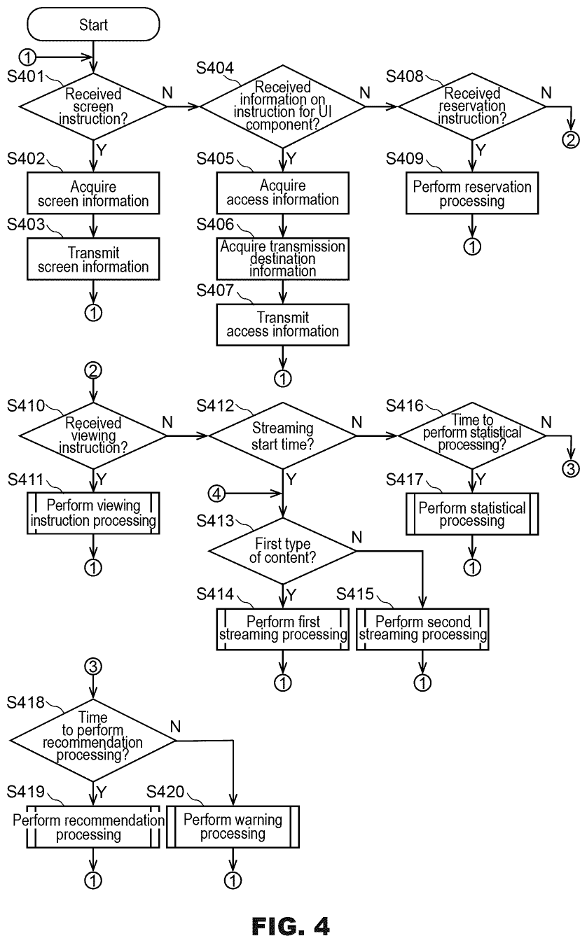

Next, an operation example of the information system A will be described. First, an operation example of the streaming apparatus 1 will be described with reference to the flowchart in FIG. 4.

(Step S401) The screen instruction receiving unit 121 determines whether or not it has received a screen instruction from a user terminal 2. If it has received a screen instruction, the procedure advances to step S402, or otherwise the procedure advances to step S404.

(Step S402) The screen acquiring unit 131 acquires screen information corresponding to the screen instruction received in step S401, from the screen storage unit 111. The screen information corresponding to the screen instruction is, for example, screen information that is identified with a screen identifier contained in the screen instruction.

(Step S403) The screen transmitting unit 141 transmits the screen information acquired in step S402, to the user terminal 2 from which the screen instruction was transmitted. The procedure returns to step S401.

(Step S404) The switching support unit 133 determines whether or not it has received information on an instruction for the UI component, from a user terminal 2. If it has received the information on an instruction, the procedure advances to step S405, or otherwise the procedure advances to step S408.

The information on an instruction for the UI component is associated with a user identifier corresponding to the user terminal 2.

(Step S405) The switching support unit 133 acquires access information (e.g., URL) corresponding to information corresponding to the instruction for the UI component, from the storage unit 11. The access information is screen information on a screen regarding the same content as that specified with information displayed on a screen containing the UI component, and is information for accessing screen information on a second-size screen of a personal computer or the like.

(Step S406) The switching support unit 133 acquires a user identifier corresponding to the information received in step S404. Next, the switching support unit 133 acquires transmission destination information (e.g., an e-mail address, a telephone number of a mobile phone) that is paired with the user identifier, from the user management unit 113.

(Step S407) The switching support unit 133 transmits the access information acquired in step S405 to the transmission destination information acquired in step S406. The procedure returns to step S401.

(Step S408) The receiving unit 12 determines whether or not it has received a reservation instruction from a user terminal 2. If the receiving unit 12 has received a reservation instruction, the procedure advances to step S409, or otherwise the procedure advances to step S410.

The reservation instruction is associated with a user identifier of a user who transmitted the reservation instruction. The reception of the reservation instruction by the receiving unit 12 is the reception of the first reservation instruction by the first reservation receiving unit 122 or the reception of the second reservation instruction by the second reservation receiving unit 123.

(Step S409) The reservation unit 132 performs reservation processing according to the reservation instruction received by the receiving unit 12 in step S408. The procedure returns to step S401.

The reservation unit 132 accumulates, for example, reservation information containing a content identifier corresponding to the received reservation instruction, in association with the user identifier corresponding to the user terminal 2 from which the reservation instruction was transmitted.

(Step S410) The receiving unit 12 determines whether or not it has received a viewing instruction from a user terminal 2. If the receiving unit 12 has received a viewing instruction, the procedure advances to step S411, or otherwise the procedure advances to step S412.

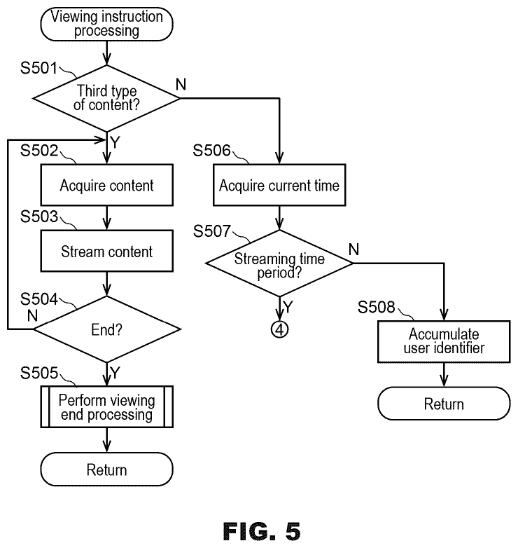

(Step S411) The processing unit 13 performs processing corresponding to the received viewing instruction. The procedure returns to step S401. Such processing is referred to as viewing instruction processing. An example of the viewing instruction processing will be described with reference to the flowchart in FIG. 5.

(Step S412) The processing unit 13 acquires the current time from an unshown clock. Next, the processing unit 13 refers to the content storage unit 112, and determines whether or not the streaming start time of the first type of content or the second type of content has arrived. If the streaming start time of content has arrived, the procedure advances to step S413, or otherwise the procedure advances to step S416.

(Step S413) The processing unit 13 refers to the content storage unit 112, and determines whether the content whose streaming start time has arrived is the first type of content or the second type of content. If it is the first type of content, the procedure advances to step S414, and if it is the second type of content, the procedure advances to step S415.

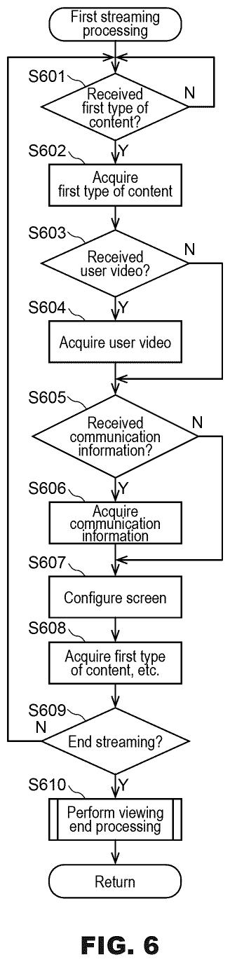

(Step S414) The first streaming unit 142 performs processing that streams the first type of content whose streaming start time has arrived. The procedure returns to step S401. Such processing is referred to as first streaming processing. An example of the first streaming processing will be described with reference to the flowchart in FIG. 6.

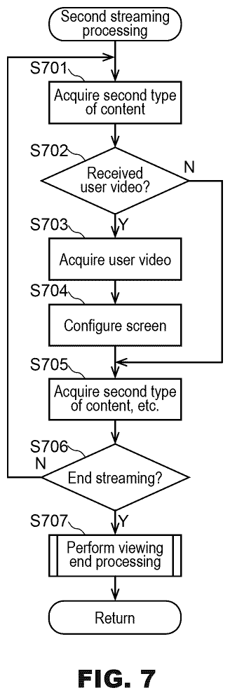

(Step S415) The second streaming unit 143 performs processing that streams the second type of content whose streaming start time has arrived. The procedure returns to step S401. Such processing is referred to as second streaming processing. An example of the second streaming processing will be described with reference to the flowchart in FIG. 7.

(Step S416) The processing unit 13 determines whether or not it is time to perform statistical processing. If it is time to perform statistical processing, the procedure advances to step S417, or otherwise the procedure advances to step S418. The time to perform statistical processing is, for example, when a predetermined time has arrived or when an instruction is received from a user.

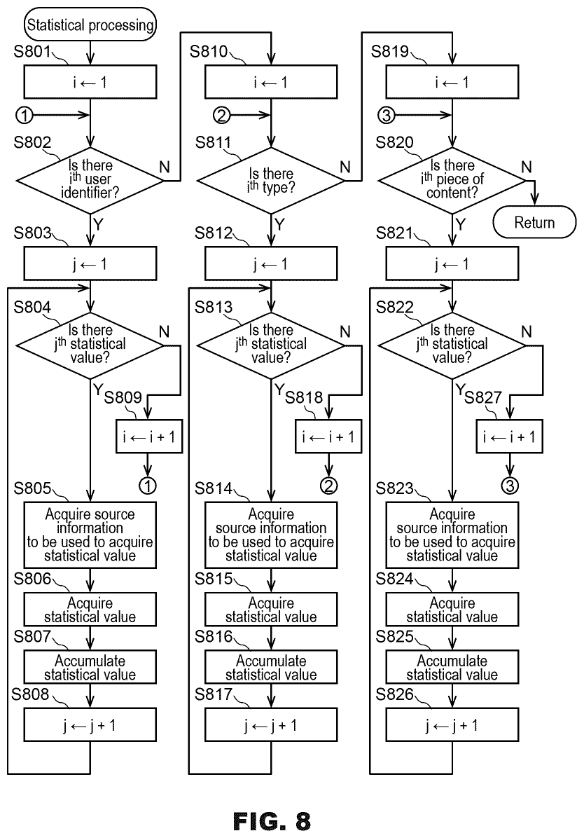

(Step S417) The statistical processing unit 138 performs statistical processing. The procedure returns to step S401. An example of the statistical processing will be described with reference to the flowchart in FIG. 8.

(Step S418) The processing unit 13 determines whether or not it is time to perform recommendation processing. If it is time to perform recommendation processing, the procedure advances to step S419, or otherwise the procedure advances to step S420. The time to perform recommendation processing is, for example, when a predetermined time has arrived or when an instruction is received from a user.

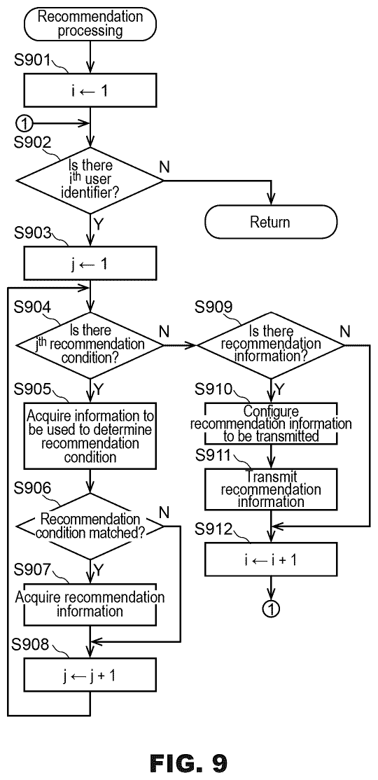

(Step S419) The recommendation acquiring unit 139 and the like perform recommendation processing. The procedure returns to step S401. An example of the recommendation processing will be described with reference to the flowchart in FIG. 9.

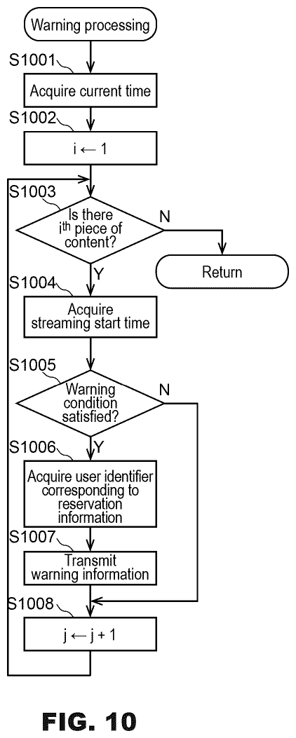

(Step S420) The processing unit 13 and the like perform warning processing for a user who has made a viewing reservation. An example of the warning processing will be described with reference to the flowchart in FIG. 10.

In the flowchart in FIG. 4, it is assumed that the streaming apparatus 1 receives various types of instructions and information (e.g., screen instructions, reservation instructions, viewing instructions, etc.) from one or more user terminals 2 and performs processing corresponding to the instructions and information, even during other processing. That is to say, it is preferable that the streaming apparatus 1 can perform various types of processing in parallel.

Furthermore, in the flowchart in FIG. 4, the processing ends at power off or at an interruption of termination processing.

Next, an example of the viewing instruction processing in step S411 will be described with reference to the flowchart in FIG. 5.

(Step S501) The processing unit 13 acquires a content identifier corresponding to the received viewing instruction. The processing unit 13 acquires a type identifier that is paired with the content identifier. The processing unit 13 determines whether or not the type identifier is a “third type of content”. If it is a “third type of content”, the procedure advances to step S502, or otherwise the procedure advances to step S506.

(Step S502) The processing unit 13 acquires a third type of content that is identified with the content identifier corresponding to the received viewing instruction, from the third storage unit 1123. The processing unit 13 typically acquires the third type of content sequentially until the end of streaming.

(Step S503) The third streaming unit 144 transmits the third type of content acquired in step S502, to the user terminal 2 from which the viewing instruction was transmitted. The third streaming unit 144 typically streams the third type of content acquired in step S502 sequentially until the end of streaming.

(Step S504) The processing unit 13 determines whether or not to end the streaming. If the streaming is to be ended, the procedure advances to step S505, or otherwise the procedure returns to step S502. The streaming is ended, for example, in the case in which the third type of content has been streamed to the end or in the case in which an end instruction is received from the user terminal 2 of a user who has been viewing the third type of content.

(Step S505) The processing unit 13 performs viewing end processing. The procedure returns to the upper-level processing. An example of the viewing end processing will be described with reference to the flowchart in FIG. 10.

(Step S506) The processing unit 13 acquires the current time from an unshown clock.

(Step S507) The processing unit 13 acquires streaming time information that is paired with the content identifier corresponding to the received viewing instruction, from the content storage unit 112. Next, the processing unit 13 determines whether or not the current time is in a streaming time period indicated by the streaming time information. If it is in the streaming time period, the procedure advances to step S413, or otherwise the procedure advances to step S508. It is assumed that if it is not in the streaming time period, in this case, a viewing reservation is to be performed. If it is in the streaming time period, the number of user terminals 2 to which the content is streamed is increased by one.

(Step S508) The processing unit 13 acquires a user identifier corresponding to the received viewing instruction, and temporarily stores the user identifier in an unshown buffer. The procedure returns to the upper-level processing. Such a buffer is a buffer in which a user identifier of a user who has made a viewing reservation is stored. When the streaming start time indicated by the streaming time information has arrived, the first streaming unit 142 or the second streaming unit 143 streams the content to the user terminals 2 respectively corresponding to the one or more user identifiers in the buffer.

Next, an example of the first streaming processing in step S414 will be described with reference to the flowchart in FIG. 6.

(Step S601) The content receiving unit 124 determines whether or not it has received a first type of content from a streamer terminal 3 corresponding to the streaming start time. If it has received a first type of content, the procedure advances to step S602, or otherwise the procedure returns to step S601.

(Step S602) The content accumulating unit 134 acquires the first type of content received in step S601. The content accumulating unit 134 accumulates the first type of content in the first storage unit 1121.

(Step S603) The user video receiving unit 128 determines whether or not it has received user videos respectively from one or two or more user terminals 2. If it has received any user videos, the procedure advances to step S604, or otherwise the procedure advances to step S605.

(Step S604) The combining unit 135 acquires the user videos acquired in step S603.

(Step S605) The communication unit 136 determines whether or not it has received communication information. If it has received communication information, the procedure advances to step S606, or otherwise the procedure advances to step S607.

(Step S606) The communication unit 136 acquires the received communication information.

(Step S607) The combining unit 135 configures a screen containing the first type of content received in step S601. Such a screen has only the first type of content, the first type of content together with one or two or more user videos, the first type of content together with one or two or more pieces of communication information, or the first type of content together with one or more user videos and one or more pieces of communication information.

(Step S608) The first streaming unit 142 streams the screen configured in step S606, to the user terminals 2 respectively corresponding to user identifiers of one or two or more users who are viewing the content. Such one or two or more user identifiers are user identifiers stored in an unshown buffer. Such one or more user identifiers are identifiers of users who are viewing the content.

(Step S609) The processing unit 13 determines whether or not to end the streaming. If the streaming is to be ended, the procedure advances to step S610, or otherwise the procedure returns to step S601. The streaming is ended, for example, in the case in which the first type of content has been streamed to the end.

(Step S610) The processing unit 13 performs viewing end processing. An example of the viewing end processing will be described with reference to the flowchart in FIG. 10.

Next, an example of the second streaming processing in step S415 will be described with reference to the flowchart in FIG. 7.

(Step S701) The second streaming unit 143 acquires a second type of content corresponding to the streaming start time, from the second storage unit 1122.

(Step S702) The user video receiving unit 128 determines whether or not it has received user videos respectively from one or two or more user terminals 2. If it has received any user videos, the procedure advances to step S703, or otherwise the procedure advances to step S605.

(Step S703) The combining unit 135 acquires the one or two or more user videos received in step S702.

(Step S704) The combining unit 135 configures a screen containing the second type of content acquired in step S701 and the one or more user videos acquired in step S703.

(Step S705) The second streaming unit 143 streams the screen containing the second type of content to user terminals 2 of users who have made a viewing reservation for the content and user terminals 2 of users who are viewing the content.

(Step S706) The processing unit 13 determines whether or not to end the streaming. If the streaming is to be ended, the procedure advances to step S707, or otherwise the procedure returns to step S701. The streaming is ended, for example, in the case in which the second type of content has been streamed to the end.

(Step S707) The processing unit 13 performs viewing end processing. An example of the viewing end processing will be described with reference to the flowchart in FIG. 10.

Next, an example of the statistical processing in step S417 will be described with reference to the flowchart in FIG. 8.

(Step S801) The statistical processing unit 138 substitutes 1 for a counter i.

(Step S802) The statistical processing unit 138 determines whether or not there is an i^{th} user identifier. If there is an i^{th} user identifier, the procedure advances to step S803, or otherwise the procedure advances to step S810.

(Step S803) The statistical processing unit 138 substitutes 1 for a counter j.

(Step S804) The statistical processing unit 138 determines whether or not there is a j^{th} statistical value that is to be acquired for each user. If there is such a j^{th} statistical value, the procedure advances to step S805, or otherwise the procedure advances to step S809. The statistical value that is to be acquired for each user is determined in advance.

(Step S805) The statistical processing unit 138 acquires one or two or more pieces of source information that are used to acquire the j^{th} statistical value that is to be acquired for each user, the information being one or more pieces of source information that are paired with the i^{th} user identifier, from the user management unit 113. The source information is, for example, a content identifier of content viewed by a user, input information input by a user, or a type identifier of content viewed by a user.

(Step S806) The statistical processing unit 138 performs an operation corresponding to the j^{th} statistical value that is to be acquired for each user, using the one or more pieces of source information acquired in step S805, thereby acquiring the j^{th} statistical value. The statistical value is, for example, the number of pieces of content viewed by a user in a unit period, the number of pieces of content viewed by a user in a unit period for each type identifier, an average satisfaction level of pieces of content viewed by a user in a unit period, or a content attribute value that is common to pieces of content viewed by a user in a unit period and having a satisfaction level that is greater than or equal to a threshold value. The statistical value is typically a numerical value, but it does not have to be a numerical value.

Furthermore, for example, it is assumed that an operation expression is stored in the storage unit 11 in association with an identifier of the j^{th} statistical value that is to be acquired for each user.

(Step S807) The statistical processing unit 138 accumulates the j^{th} statistical value acquired in step S806 in the user management unit 113 in a pair with the i^{th} user identifier.

(Step S808) The statistical processing unit 138 increments the counter j by 1. The procedure returns to step S804.

(Step S809) The statistical processing unit 138 increments the counter i by 1. The procedure returns to step S802.

(Step S810) The statistical processing unit 138 substitutes 1 for a counter i.

(Step S811) The statistical processing unit 138 determines whether or not there is an i^{th} type. If there is an i^{th} type, the procedure advances to step S812, or otherwise the procedure advances to step S818. The type is, for example, any of the three types “first type of content”, “second type of content”, and “third type of content”.

(Step S812) The statistical processing unit 138 substitutes 1 for a counter j.

(Step S813) The statistical processing unit 138 determines whether or not there is a j^{th} statistical value that is to be acquired for each type of content. If there is such a j^{th} statistical value, the procedure advances to step S814, or otherwise the procedure advances to step S818. The statistical value that is to be acquired for each type of content is determined in advance.

(Step S814) The statistical processing unit 138 acquires one or two or more pieces of source information that are used to acquire the j^{th} statistical value that is to be acquired for each type of content, the information being one or more pieces of source information that are paired with the i^{th} type identifier, from the content storage unit 112. The source information is, for example, a user identifier of a user who has viewed the content or input information input by a user who has viewed the content.

(Step S815) The statistical processing unit 138 performs an operation corresponding to the j^{th} statistical value that is to be acquired for each type of content, using the one or more pieces of source information acquired in step S814, thereby acquiring the j^{th} statistical value. The statistical value is, for example, the number of viewers in a unit period for each type of content or an average satisfaction level for each type of content.

For example, it is assumed that an operation expression is stored in the storage unit 11 in association with an identifier of the j^{th} statistical value that is to be acquired for each type of content.

(Step S816) The statistical processing unit 138 accumulates the j^{th} statistical value acquired in step S815 in the content storage unit 112 in a pair with the i^{th} type identifier.

(Step S817) The statistical processing unit 138 increments the counter j by 1. The procedure returns to step S813.

(Step S818) The statistical processing unit 138 increments the counter i by 1. The procedure returns to step S811.

(Step S819) The statistical processing unit 138 substitutes 1 for a counter i.

(Step S820) The statistical processing unit 138 determines whether or not there is an i^{th} piece of content. If there is an i^{th} piece of content, the procedure advances to step S821, or otherwise the procedure returns to the upper-level processing.

(Step S821) The statistical processing unit 138 substitutes 1 for a counter j.

(Step S822) The statistical processing unit 138 determines whether or not there is a j^{th} statistical value that is to be acquired for each piece of content. If there is such a j^{th} statistical value, the procedure advances to step S823, or otherwise the procedure advances to step S827. The statistical value that is to be acquired for each piece of content is determined in advance.

(Step S823) The statistical processing unit 138 acquires one or two or more pieces of source information that are used to acquire the j^{th} statistical value that is to be acquired for each piece of content, the information being one or more pieces of source information that are paired with the i^{th} content identifier, from the content storage unit 112. The source information is, for example, a user identifier of a user who has viewed the content or input information input by a user who has viewed the content.

(Step S824) The statistical processing unit 138 performs an operation corresponding to the j^{th} statistical value that is to be acquired for each piece of content, using the one or more pieces of source information acquired in step S823, thereby acquiring the j^{th} statistical value. The statistical value is, for example, the number of viewers in a unit period for each piece of content or an average satisfaction level for each piece of content.

For example, it is assumed that an operation expression is stored in the storage unit 11 in association with an identifier of the j^{th} statistical value that is to be acquired for each piece of content.

(Step S825) The statistical processing unit 138 accumulates the j^{th} statistical value acquired in step S824 in the content storage unit 112 in a pair with the i^{th} content identifier.

(Step S826) The statistical processing unit 138 increments the counter j by 1. The procedure returns to step S822.

(Step S827) The statistical processing unit 138 increments the counter i by 1. The procedure returns to step S820.

Next, an example of the recommendation processing in step S419 will be described with reference to the flowchart in FIG. 9.

(Step S901) The recommendation acquiring unit 139 substitutes 1 for a counter i.

(Step S902) The recommendation acquiring unit 139 determines whether or not there is an i^{th} user identifier in the user management unit 113. If there is an i^{th} user identifier, the procedure advances to step S903, or otherwise the procedure returns to the upper-level processing.

(Step S903) The recommendation acquiring unit 139 substitutes 1 for a counter j.

(Step S904) The recommendation acquiring unit 139 determines whether or not there is a j^{th} recommendation condition in the storage unit 11. If there is a j^{th} recommendation condition, the procedure advances to step S905, or otherwise the procedure advances to step S909.

(Step S905) The recommendation acquiring unit 139 acquires one or two or more pieces of information that are used to determine the j^{th} recommendation condition, the information being one or more pieces of information that are paired with the i^{th} user identifier. The pieces of information that are used to determine the recommendation condition are, for example, one or more content attribute values of the content whose satisfaction level of a user is greater than or equal to a threshold value, or the satisfaction level of two or more users for a piece of content.

(Step S906) The recommendation acquiring unit 139 determines whether or not any of the one or more pieces of information acquired in step S905 matches the j^{th} recommendation condition. If any of the information matches the j^{th} recommendation condition, the procedure advances to step S907, or otherwise the procedure advances to step S908.

(Step S907) The recommendation acquiring unit 139 acquires recommendation information corresponding to the j^{th} recommendation condition from the storage unit 11 and temporarily stores the recommendation information in an unshown buffer.

(Step S908) The recommendation acquiring unit 139 increments the counter j by 1. The procedure returns to step S904.

(Step S909) The recommendation acquiring unit 139 determines whether or not there is recommendation information in the unshown buffer. If there is recommendation information, the procedure advances to step S910, or otherwise the procedure advances to step S912.

(Step S910) The recommendation transmitting unit 145 reads one or more pieces of recommendation information from the unshown buffer, and configures recommendation information that is to be transmitted.

(Step S911) The recommendation transmitting unit 145 acquires transmission destination information that is paired with the i^{th} user identifier, from the user management unit 113. Next, the recommendation transmitting unit 145 transmits the recommendation information configured in step S910, to the transmission destination indicated by the transmission destination information.

(Step S912) The recommendation transmitting unit 145 increments the counter i by 1. The procedure returns to step S902.

Next, an example of the warning processing in step S420 will be described with reference to the flowchart in FIG. 10.

(Step S1001) The processing unit 13 acquires the current time from an unshown clock.

(Step S1002) The processing unit 13 substitutes 1 for a counter i.

(Step S1003) The processing unit 13 determines whether or not there is an i^{th} piece of content whose streaming is to be started at a scheduled time. If there is such an i^{th} piece of content, the procedure advances to step S1004, or otherwise the procedure returns to the upper-level processing.

(Step S1004) The processing unit 13 acquires a streaming start time contained in the streaming time information that is paired with a content identifier of the i^{th} piece of content.

(Step S1005) The processing unit 13 determines whether or not the current time satisfies a warning condition (e.g., “streaming start time−current time<=threshold value”), using the streaming start time and the current time. If it satisfies the warning condition, the procedure advances to step S1006, or otherwise the procedure advances to step S1008.

(Step S1006) The processing unit 13 acquires a user identifier corresponding to each of the one or more pieces of reservation information corresponding to the content identifier of the i^{th} piece of content. That is to say, the processing unit 13 acquires one or more user identifiers of users who have made a viewing reservation for the i^{th} piece of content.

(Step S1007) The transmitting unit 14 acquires transmission destination information that is paired with each of the one or more user identifiers acquired in step S1006, from the user management unit 113. Next, the transmitting unit 14 transmits warning information indicating that the streaming of the i^{th} piece of content will start soon, to the transmission destination indicated by each of the one or more pieces of transmission destination information.

(Step S1008) The processing unit 13 increments the counter i by 1. The procedure returns to step S1003.

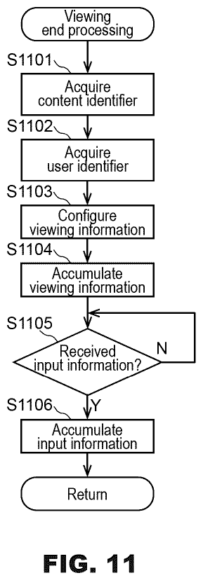

Next, an example of the viewing end processing in step S505 and the like will be described with reference to the flowchart in FIG. 11.

(Step S1101) The processing unit 13 acquires the content identifier of the viewed content.

(Step S1102) The processing unit 13 acquires the user identifier of each of the one or more users who has viewed the content.

(Step S1103) The processing unit 13 configures viewing information using the content identifier acquired in step S1101 and the one or more user identifiers acquired in step S1102. The viewing information has, for example, a content identifier and a user identifier.

(Step S1104) The processing unit 13 accumulates the one or two or more pieces of viewing information configured in step S1103, in the storage unit 11.

(Step S1105) The input information receiving unit 129 determines whether or not it has received input information from one or more user terminals 2. If it has received input information, the procedure advances to step S1106, or otherwise the procedure returns to step S1105.

(Step S1106) The input information accumulating unit 137 accumulates the one or more pieces of input information received in step S1105. The procedure returns to the upper-level processing. The input information accumulating unit 137 accumulates the received input information, for example, in association with a user identifier and a content identifier.

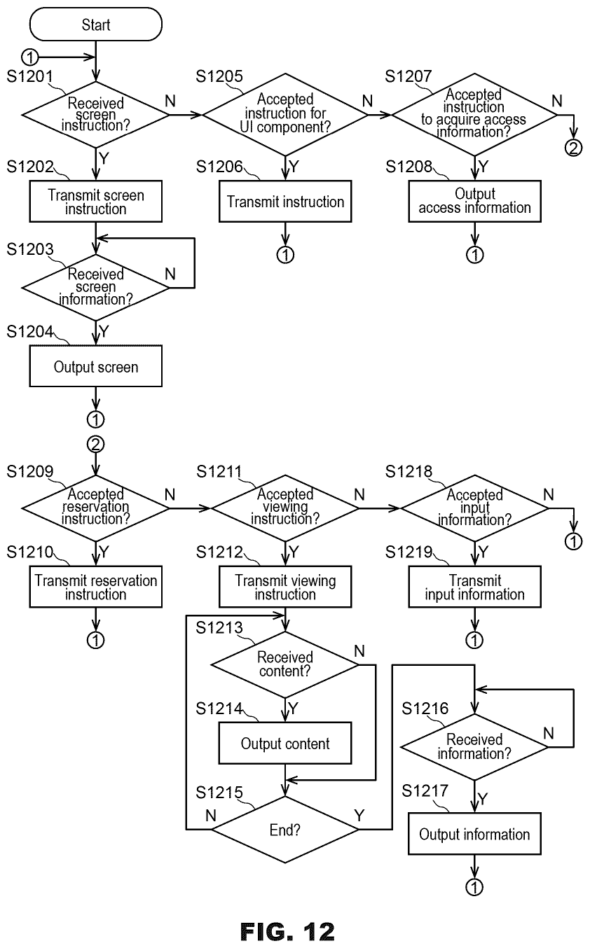

Next, an operation example of a user terminal 2 will be described with reference to the flowchart in FIG. 12.

(Step S1201) The user accepting unit 22 determines whether or not it has accepted a screen instruction. If it has accepted a screen instruction, the procedure advances to step S1202, or otherwise the procedure advances to step S1205.

(Step S1202) The user processing unit 23 configures a screen instruction that is to be transmitted. The user transmitting unit 24 transmits the screen instruction to the streaming apparatus 1.

(Step S1203) The user receiving unit 25 determines whether or not it has received screen information from the streaming apparatus 1. If it has received screen information, the procedure advances to step S1204, or otherwise the procedure returns to step S1203.

(Step S1204) The user processing unit 23 configures a screen that is to be output, using the received screen information. The user output unit 26 outputs the screen configured in step S1204. The procedure returns to step S1201.

(Step S1205) The user accepting unit 22 determines whether or not it has accepted an instruction for the UI component. If it has accepted such an instruction, the procedure advances to step S1206, or otherwise the procedure advances to step S1207.

(Step S1206) The user processing unit 23 configures an instruction that is to be transmitted. The user transmitting unit 24 transmits the instruction to the streaming apparatus 1. The procedure returns to step S1201.

(Step S1207) The user accepting unit 22 determines whether or not it has accepted an instruction to acquire access information. If it has accepted such an instruction, the procedure advances to step S1208, or otherwise the procedure advances to step S1209. The instruction to acquire access information is, for example, an instruction to open an e-mail mailer or an instruction to open a corresponding e-mail.

(Step S1208) The user processing unit 23 acquires access information in response to the instruction to acquire access information. The user output unit 26 outputs the access information. The procedure returns to step S1201. The output of the access information is, for example, the output of one e-mail.

(Step S1209) The user accepting unit 22 determines whether or not it has accepted a reservation instruction. If it has accepted a reservation instruction, the procedure advances to step S1210, or otherwise the procedure advances to step S1211. The reservation instruction has, for example, a content identifier.

(Step S1210) The user processing unit 23 configures a reservation instruction that is to be transmitted. The user transmitting unit 24 transmits the reservation instruction to the streaming apparatus 1. The procedure returns to step S1201. The reservation instruction that is to be transmitted typically has a user identifier.

(Step S1211) The user accepting unit 22 determines whether or not it has accepted a viewing instruction. If it has accepted a viewing instruction, the procedure advances to step S1212, or otherwise the procedure advances to step S1218. The viewing instruction has, for example, a content identifier.

(Step S1212) The user processing unit 23 configures a viewing instruction that is to be transmitted. The user transmitting unit 24 transmits the viewing instruction to the streaming apparatus 1. The viewing instruction that is to be transmitted typically has a user identifier.

(Step S1213) The user receiving unit 25 determines whether or not it has received content corresponding to the viewing instruction from the streaming apparatus 1. If it has received such content, the procedure advances to step S1214, or otherwise the procedure advances to step S1215. The content in this case may contain user videos and communication information.

(Step S1214) The user processing unit 23 configures a screen containing the received content. The user output unit 26 outputs the configured screen.

(Step S1215) The user processing unit 23 determines whether or not to end the processing that outputs the content. If the processing is to be ended, the procedure advances to step S1216, or otherwise the procedure returns to step S1213.

(Step S1216) The user accepting unit 22 determines whether or not it has accepted input information. If it has accepted input information, the procedure advances to step S1217, or otherwise the procedure returns to step S1216.

(Step S1217) The user processing unit 23 configures input information and the like that are to be transmitted. The input information and the like have, for example, input information and a content identifier and a user identifier. Next, the user transmitting unit 24 transmits the input information and the like to the streaming apparatus 1. The procedure returns to step S1201.

(Step S1218) The user receiving unit 25 determines whether or not it has received information from the streaming apparatus 1. If it has received information, the procedure advances to step S1219, or otherwise the procedure returns to step S1201.

(Step S1219) The user processing unit 23 configures a screen that is to be output, using the received information. The user output unit 26 outputs the configured screen. The procedure returns to step S1201. The screen contains the received information. The information in this case is, for example, recommendation information, warning information, or statistical processing results.

In the flowchart in FIG. 12, the user accepting unit 22 of the user terminal 2 may accept communication information, the user processing unit 23 may change the communication information into communication information that is to be transmitted, and the user transmitting unit 24 may transmit the communication information to the streaming apparatus 1. It is preferable that such communication information is accepted only while the first type of content is being viewed. However, the user accepting unit 22 may accept communication information while the second type of content is being viewed.

Furthermore, in the flowchart in FIG. 12, the processing ends at power off or at an interruption of termination processing.

Next, an operation example of a streamer terminal 3 will be described. For example, when the streaming start time indicated by the streaming time information has arrived, a camera included in the streamer terminal 3 starts to capture video of a streamer (e.g., a trainer) who is doing a workout in response to an instruction from the streamer. The streamer accepting unit 32 acquires the captured video. The streamer accepting unit 32 acquires the streamer's voice collected by a microphone included in the streamer terminal 3. Next, the streamer processing unit 33 configures a first type of content that is to be transmitted. The first type of content in this case has video and audio. Next, the streamer transmitting unit 34 transmits the configured first type of content to the streaming apparatus 1.

The streamer terminal 3 continues to acquire the first type of content and transmit the content to the streaming apparatus 1 until the streamer inputs an instruction to end the streaming or until the streaming end time indicated by the streaming time information has arrived.

Furthermore, for example, the streamer terminal 3 receives screen information containing user videos of one or two or more users who are viewers of the first type of content that is being streamed by the streamer, and outputs a screen using the screen information. For example, the streamer terminal 3 receives screen information containing input information from one or two or more users who are viewers of the first type of content that is being streamed by the streamer, and outputs a screen using the screen information. For example, the streamer terminal 3 receives statistical processing results from the streaming apparatus 1 and outputs the statistical processing results.

Hereinafter, specific operation examples of the information system A in this embodiment will be described.

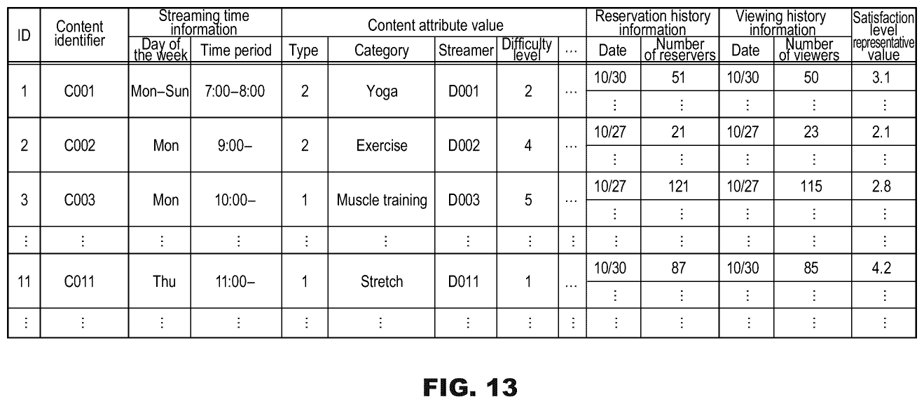

It is assumed that a content management table having the structure shown in FIG. 13 is stored in the content storage unit 112 of the streaming apparatus 1. The content management table is a table for managing information on content. The content management table manages one or more records each having “ID”, “content identifier”, “streaming time information”, “content attribute value”, “reservation history information”, “viewing history information”, and “satisfaction level representative value”. The “streaming time information” has “day of the week” and “time period”. The “content attribute value” has “type”, “category”, “streamer”, and “difficulty level”. The “reservation history information” has “date” and “number of reservers”. The “viewing history information” has “date” and “number of viewers”.

The “ID” is information for identifying a record. The “content identifier” in this case is a content ID, but it may be a content name or the like. The “time period” may have only a start time or both a start time and an end time. The “type” is a type identifier. The “category” is a category identifier. The “streamer” is a streamer identifier. The “difficulty level” is a difficulty level identifier. The “number of reservers” is the number of users who have made a viewing reservation for the corresponding content. The “number of viewers” is the number of users who have viewed the corresponding content. The “satisfaction level representative value” in this case is the mean of the satisfaction level transmitted from the user terminals 2 to the streaming apparatus 1 by two or more viewers after viewing the corresponding content.

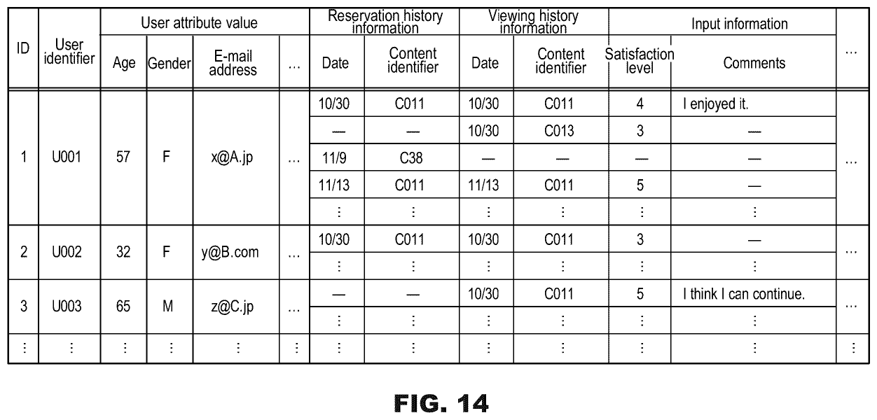

Furthermore, it is assumed that a user management table having the structure shown in FIG. 14 is stored in the user management unit 113 of the streaming apparatus 1. The user management table is a table for managing information on users. The user management table manages one or more records each having “ID”, “user identifier”, “user attribute value”, “reservation history information”, “viewing history information”, and “input information”. The “user attribute value” has “age”, “gender”, and “e-mail address”. The “reservation history information” has “date” and “content identifier”. The “viewing history information” has “date” and “content identifier”. The “input information” has “satisfaction level” and “comments”. The “content identifier” of the “reservation history information” is an identifier of content reserved for viewing by a user. The “content identifier” of the “viewing history information” is an identifier of content viewed by a user. The “input information” is information input by a user after the user's viewing of the content and transmitted from the user terminal 2 to the streaming apparatus 1.

In this situation, the following three specific examples will be described. In Specific Example 1, a user interface will be described that guides a user from a screen output by the user terminal 2 that is a smartphone, which can easily make viewing reservations and display a content list and the like, to a personal computer, which has a larger screen size and makes viewing of content easier. In Specific Example 2, processing will be described that while viewing a first type of content, a user is allowed to view user videos of other users and to transmit information to a streamer (trainer). In Specific Example 3, processing will be described that while viewing a second type of content or a third type of content, a user is not allowed to view user videos of other users but is allowed to view his or her own video.

### Specific Example 1

It is assumed that a user A identified with the user identifier “U001” inputs a screen instruction to output a content streaming schedule to a user terminal 2S, which is his or her smartphone. Then, the user terminal 2S accepts the screen instruction, and transmits the screen instruction to output a content streaming schedule, to the streaming apparatus 1.

Next, the streaming apparatus 1 receives the screen instruction, refers to the content management table in FIG. 13, configures screen information on the content streaming schedule, and transmits the screen information to the user terminal 2S.

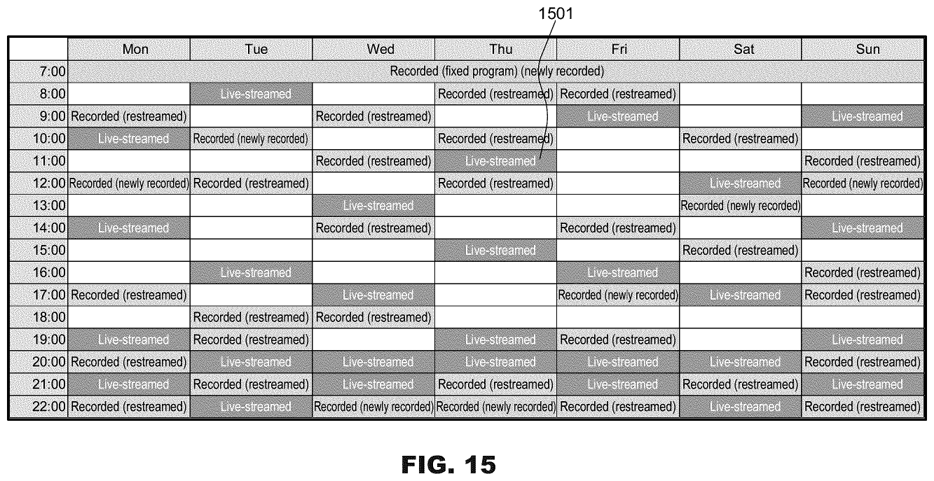

Next, the user terminal 2S receives the screen information on the content streaming schedule, configures a screen of the content streaming schedule using the screen information, and outputs the screen. FIG. 15 shows such a screen example.

Next, it is assumed that the user A instructs a box for 1501 in FIG. 15 in order to make a viewing reservation for content 1501 in FIG. 15.

Then, the user terminal 2S accepts a screen instruction corresponding to 1501 in FIG. 15. Such a screen instruction is an instruction to transmit screen information on a viewing reservation for the content (lesson reservation) corresponding to 1501 in FIG. 15. The user terminal 2S transmits the screen instruction to the streaming apparatus 1.

Next, the streaming apparatus 1 receives the screen instruction. The streaming apparatus 1 acquires screen information corresponding to the screen instruction, from the screen storage unit 111, and transmits the screen information to the user terminal 2S.

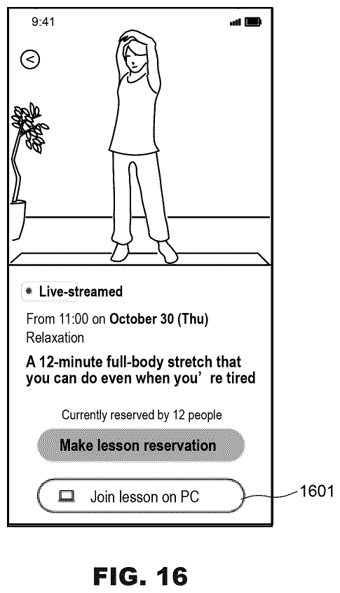

Next, the user terminal 2S receives the screen information, and outputs a screen corresponding to the screen information. FIG. 16 shows such a screen example. FIG. 16 shows a screen example of a smartphone.

Next, it is assumed that the user A wants to use a personal computer with a larger screen size for viewing the first type of content, and instructs a “join lesson on PC” button 1601 on the screen (FIG. 16) of the user terminal 2S.

Next, the user accepting unit 22 of the user terminal 2S accepts the instruction for an UI component 1601. Next, the user processing unit 23 configures an instruction that is to be transmitted. Such an instruction is an instruction to transmit a URL for accessing a first type of content (live-streamed content) 1501. It is assumed that this instruction includes the content identifier “C011” corresponding to the first type of content (live-streamed content) 1501. Next, the user transmitting unit 24 transmits the instruction to the streaming apparatus 1.

Next, the switching support unit 133 of the streaming apparatus 1 receives the information on the instruction for the UI component 1601, from the user terminal 2S. Next, the switching support unit 133 acquires access information corresponding to the information corresponding to the instruction for the UI component, from the storage unit 11. It is assumed that the access information in this case is a URL to the content identified with the content identifier “C011”.

Next, the switching support unit 133 acquires the user identifier “U001” corresponding to the received information. Next, it is assumed that the switching support unit 133 acquires transmission destination information (in this case, the e-mail address “x@A.jp” of the user A) that is paired with the user identifier, from the user management table. Next, the switching support unit 133 transmits an email containing the acquired access information, to the acquired e-mail address “x@A.jp”.

Next, it is assumed that the user A change the terminal that is to be used, to a user terminal 2P that is a personal computer, starts a mailer, and opens an email addressed to the e-mail address “x@A.jp”. It is assumed that the email contains a URL to access a first type of content (live-streamed content) 1501 for accessing. Next, it is assumed that the user A instructs the URL on the screen of the user terminal 2P.

Then, the user accepting unit 22 of the user terminal 2P accepts the viewing instruction of the first type of content 1501. Next, the user processing unit 23 configures a viewing instruction that is to be transmitted. Next, the user transmitting unit 24 transmits the viewing instruction to the streaming apparatus 1. It is assumed that such a viewing instruction corresponds to the content identifier “C011” of the first type of content 1501.

Next, the receiving unit 12 of the streaming apparatus 1 receives the viewing instruction from the user terminal 2P. The processing unit 13 detects that it is time to start the streaming of the first type of content 1501. The content receiving unit 124 receives the first type of content identified with the content identifier “C011” from the streamer terminal 3 corresponding to the first type of content 1501. The first streaming unit 142 streams a screen containing the received first type of content to the user terminals 2 corresponding to user identifiers of two or more users including the user A.

Next, the user terminals 2 of two or more users including the user A receive and output the first type of content identified with the content identifier “C011”.

As described above, according to this specific example, the user can, for example, switch from a smartphone, which can easily display a content list and make viewing reservations and the like using a touch screen to a personal computer, which has a larger screen size and makes viewing of content easier, and view the content.

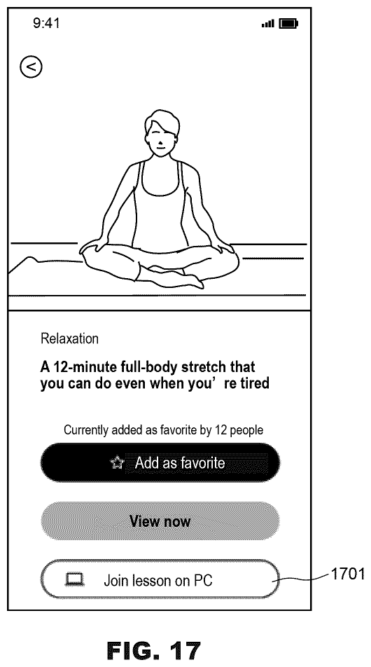

If the content that the user wants to view is content that cannot be reserved (e.g., the third type of content or content whose streaming start time has passed and is being streamed), the screen on the user terminal 2 will be as shown in FIG. 17 instead of FIG. 16, for example. In such a screen as well, there is a UI component 1701 on the screen (FIG. 17) to guide the user from a smartphone with a small screen to a personal computer, which has a larger screen size and makes viewing of content easier.

### Specific Example 2

It is assumed that 85 users including the user A are currently viewing the first type of content 1501 and doing a workout.

It is assumed that five users out of 85 viewers allow the user videos to be streamed to others. It is assumed that a flag specifying whether or not to allow streaming of a user video to others is stored in the storage unit 11 of the streaming apparatus 1 in association with a user identifier, for example. The flag that specifies whether or not to allow streaming of a user video to others is referred to as a permission flag.

The content receiving unit 124 of the streaming apparatus 1 continues to receive the first type of content from the streamer terminal 3. The content accumulating unit 134 acquires the received first type of content and accumulates the content in the first storage unit 1121.

Furthermore, the user video receiving unit 128 receives user videos from five or six or more user terminals 2 including the user terminals 2 corresponding to whose permission flag corresponds to the “allow streaming to others” value. The combining unit 135 acquires the received first type of content and five user videos corresponding to five user identifiers that are paired with the permission flag that allows streaming of user videos to others. Next, the combining unit 135 combines the first type of content and the five user videos, and configures screen information containing the five user videos. Next, the first streaming unit 142 streams the combined screen information to the user terminals 2 respectively corresponding to the user identifiers of the users who are viewing the content and the streamer terminal 3. The first streaming unit 142 may transmit screen information containing the five user videos to the user terminals 2 of all 85 viewers, or may transmit the screen information to only the user terminals 2 of the five viewers who are providing the user videos. If the screen information containing the five user videos is transmitted to only the user terminals 2 of the five viewers, the first streaming unit 142 transmits screen information not containing the five user videos to the user terminals 2 of the other 80 viewers.

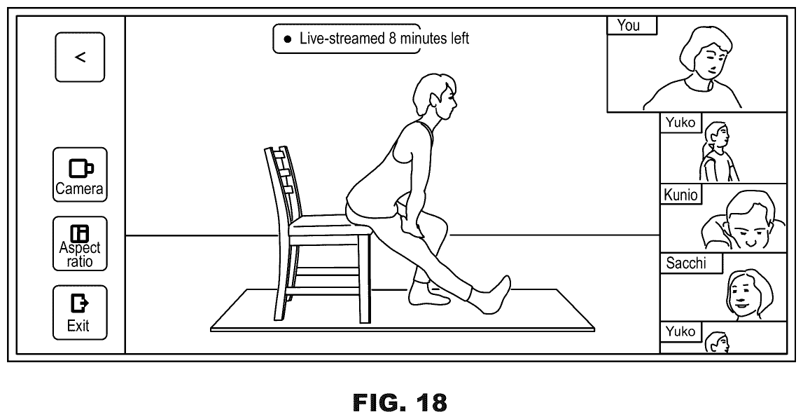

At least the user terminals 2 corresponding to the permission flag that allows streaming to others receive screen information in which the first type of content and five user videos are combined, configure a screen using the screen information, and output the screen. FIG. 18 shows an example of the screen containing the five user videos. In the screen shown in FIG. 18, the user can grasp how users other than himself or herself are engaged in the workout, which can improve the efficiency of workout and make the workout more enjoyable.

Furthermore, it is assumed that during the output of the screen shown in FIG. 18, the user A inputs “My back hurts, can I do the workout while standing?” via chat or voice on his or her user terminal 2P.

Then, the user terminal 2P accepts the communication information “My back hurts, can I do the workout while standing?”, and transmits the communication information to the streaming apparatus 1.

Next, the communication unit 136 of the streaming apparatus 1 receives the communication information. The combining unit 135 configures screen information containing the received first type of content, the five user videos, and the communication information. Next, the first streaming unit 142 streams the configured screen information to the user terminals 2 respectively corresponding to the user identifiers of the users who are viewing the first type of content and the streamer terminal 3.

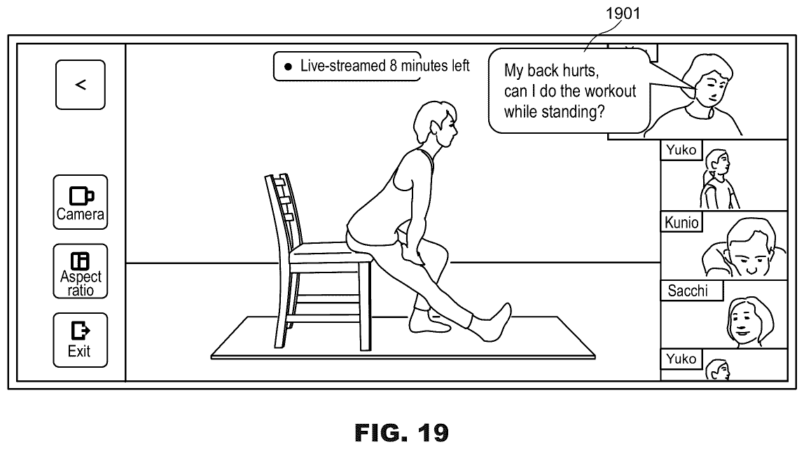

Next, the user terminals 2 and the streamer terminal 3 receive the screen information containing the first type of content, the five user videos, and the communication information, configure a screen using the screen information, and output the screen. FIG. 19 shows such an output example.

The streamer who sees or hears the communication information 1901 in FIG. 19 says “It's okay. Please do the workout while standing.” and such voice is transmitted to the streaming apparatus 1, and then transmitted via the streaming apparatus 1 to the user's user terminals 2 and output therefrom.

As described above, according to this specific example, the user can view user videos of other users and transmit information the streamer (trainer) while the user is viewing the first type of content.

In this specific example, it is preferable that the user's voice information is recognized by the user terminals 2 or the streaming apparatus 1 and the acquired text string is transmitted to the one or two or more user terminals 2 and the streamer terminal 3.

### Specific Example 3

Next, it is assumed that a user inputs a viewing instruction of the second type of content or the third type of content to the user terminal 2. Then, the viewing instruction is transmitted from the user terminal 2 to the streaming apparatus 1. In this case, it is assumed that the viewing instruction contains the content identifier “C001”.

Next, the streaming apparatus 1 receives the viewing instruction. Next, the processing unit 13 acquires a type identifier “2” that is paired with the content identifier “C001” from the content management table (FIG. 13). The processing unit 13 acquires the current time “7:00” from an unshown clock. Next, the processing unit 13 acquires streaming time information “<day of the week> Mon-Sun <time period> 7:00-8:00” that is paired with the content identifier “C001”, from the content management table (FIG. 13). Next, the processing unit 13 determines that the current time is in a streaming time period indicated by the streaming time information.

Next, the second streaming unit 143 performs the second streaming processing. That is to say, the second streaming unit 143 reads the content with the content identifier “C001” from the second storage unit 1122, and streams the content to the user terminals 2 of one or more users who have made a viewing reservation or who have transmitted a viewing instruction.

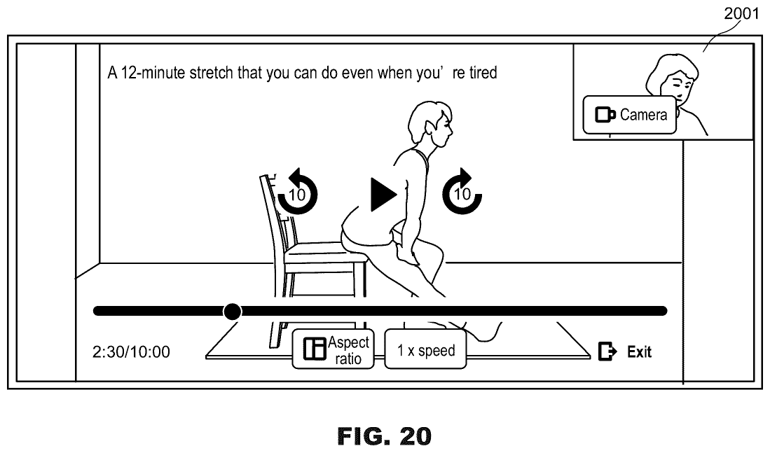

Next, each user terminal 2 receives the content with the content identifier “C001”. The user terminal 2 combines and outputs an image captured by a camera contained in the user terminal 2 and the received second type of content. FIG. 20 shows such an output example. In FIG. 20, the user can do a workout appropriately by comparing the instructor's video and his or her own video (2001) captured by the camera of the user terminal 2. In FIG. 20, the user cannot view user videos of other users.

As described above, according to this specific example, the user cannot view user videos of other users while viewing the second type of content or the third type of content, but can view his or her own video. As a result, users who are not good at workout can obtain videos to improve their own athletic ability without being embarrassed.

As described above, according to this embodiment, it is possible for a user to select and view the content according to user's preferences, life rhythm, and the like from among three or more types of content.

Furthermore, according to this embodiment, it is possible for a user to know or not to know other users' status according to the type of content, and to select and view the content according to user's preferences and the like. In this embodiment, it is preferable that the same content can be provided as three or more types of content including the first type of content, the second type of content, and the third type of content to a user. In this embodiment, it is preferable that the same content is prepared as two or more types of content including the first type of content and the second type of content or two or more types of content including the first type of content and the third type of content in the same time period, and can be selected by the user.

Furthermore, in this embodiment, a user may view user videos of other users also when viewing a second type of content, which is recorded content.

Furthermore, according to this embodiment, it is possible to perform statistical processing based on the input of users regarding three or more types of content, thereby acquiring statistical processing results. The performing processing based on the input of users is, for example, performing processing based on input information, viewing reservations, viewing instructions, or the like.

Furthermore, according to this embodiment, it is possible to perform statistical processing for each type of content based on the input of users regarding three or more types of content, thereby acquiring statistical processing results.

Furthermore, according to this embodiment, it is possible to perform statistical processing based on information on viewing reservations for the content, thereby acquiring statistical processing results.

Furthermore, according to this embodiment, it is possible to perform statistical processing based on the input of users regarding three or more types of content, and to make recommendations to users using the statistical processing results.

Furthermore, according to this embodiment, it is possible to perform statistical processing based on users' viewing history, reservation history, or input information for three or more types of content, and to make recommendations to users using the statistical processing results.

Moreover, according to this embodiment, it is possible to transmit communication information from users to a streamer while the first type of content is being streamed. In this embodiment, communication information from other users may be transmitted to a user while the first type of content is being streamed.

The processing in this embodiment may be realized by software. The software may be distributed by software downloads or the like. The software may be distributed in a form where the software is stored in a recording medium such as a CD-ROM. The same applies to other embodiments in this specification. The software that realizes the streaming apparatus 1 in this embodiment is the following sort of program. Specifically, this program is a program for causing a computer to function as: a first receiving unit that receives a first instruction, which is an instruction to stream a first type of content that is transmitted from a streamer terminal of the content, from a user terminal, in a time period that is specified with first streaming time information; a content receiving unit that receives the first type of content transmitted from the streamer terminal, in the time period that is specified with the first streaming time information; a first streaming unit that streams the first type of content received by the content receiving unit to the user terminal from which the first instruction was transmitted, in the time period that is specified with the first streaming time information; a second receiving unit that receives a second instruction, which is an instruction to stream a second type of content that is streamed in a time period that is specified with second streaming time information, from a user terminal; a second streaming unit that acquires the second type of content corresponding to the second instruction received by the second receiving unit and streams the second type of content to the user terminal from which the second instruction was transmitted, at the time that is specified with the second streaming time information corresponding to the second type of content, the second type of content being acquired from a second storage unit in which the second type of content is stored that is associated with the second streaming time information and that is streamed to the user terminal in the time period that is specified with the second streaming time information; a third receiving unit that receives a third instruction, which is an instruction to stream a third type of content that is streamed on demand, from a user terminal; and a third streaming unit that acquires the third type of content corresponding to the third instruction received by the third receiving unit, from a third storage unit in which the third type of content that is streamed on demand is stored, and streams the third type of content to the user terminal from which the third instruction was transmitted.

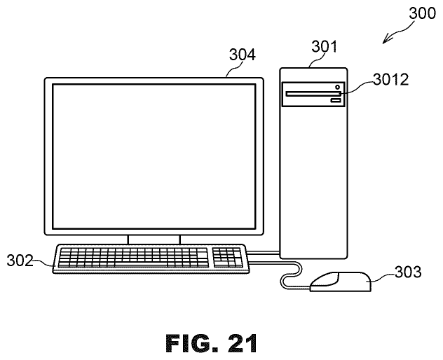

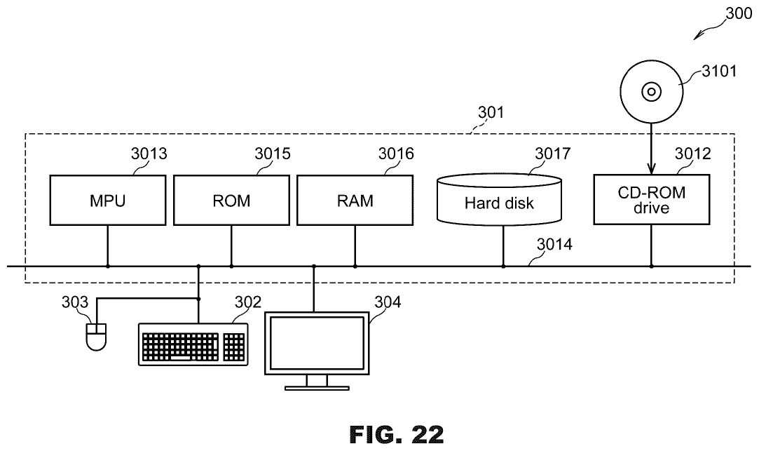

FIG. 21 shows the external appearance of a computer that executes the program described in this specification to realize the streaming apparatus 1 and the like in various embodiments described above. The foregoing embodiments may be realized using computer hardware and a computer program executed thereon. FIG. 21 is a schematic view of a computer system 300. FIG. 22 is a block diagram of the system 300.

In FIG. 21, the computer system 300 includes a computer 301 including a CD-ROM drive, a keyboard 302, a mouse 303, and a monitor 304.

In FIG. 22, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which programs such as an application program and a system program and data are stored. Although not shown, the computer 301 may further include a network card that provides connection to a LAN.

The program for causing the computer system 300 to execute the functions of the streaming apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or loaded directly from a network.

The program does not necessarily have to include, for example, an operating system (OS) or a third party program to cause the computer 301 to execute the functions of the streaming apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be constituted by a single computer, or constituted by multiple computers. That is to say, centralized processing may be performed, or distributed processing may be performed.

Furthermore, in the foregoing embodiments, it will be appreciated that at least two communication parts in one apparatus may be physically realized by one medium.

In the foregoing embodiments, each process may be realized as centralized processing using a single apparatus, or may be realized as distributed processing using multiple apparatuses.

The present invention is not limited to the embodiments set forth herein. Various modifications are possible within the scope of the present invention.

### INDUSTRIAL APPLICABILITY

As described above, the streaming apparatus 1 according to the present invention has an effect of making it possible for a user to select and view the content according to user's preferences, life rhythm, and the like, thus rendering this apparatus useful as a server that streams content and the like.

1. A streaming apparatus comprising:
a first receiving unit that receives a first instruction, which is an instruction to stream a first type of content that is transmitted from a streamer terminal of the content, from a user terminal, in a time period that is specified with first streaming time information;
a content receiving unit that receives the first type of content transmitted from the streamer terminal, in the time period that is specified with the first streaming time information;
a first streaming unit that streams the first type of content received by the content receiving unit to the user terminal from which the first instruction was transmitted, in the time period that is specified with the first streaming time information;
a second receiving unit that receives a second instruction, which is an instruction to stream a second type of content that is streamed in a time period that is specified with second streaming time information, from a user terminal;
a second streaming unit that acquires the second type of content corresponding to the second instruction received by the second receiving unit and streams the second type of content to the user terminal from which the second instruction was transmitted, at the time that is specified with the second streaming time information corresponding to the second type of content, the second type of content being acquired from a second storage unit in which the second type of content is stored that is associated with the second streaming time information and that is streamed to the user terminal in the time period that is specified with the second streaming time information;
a third receiving unit that receives a third instruction, which is an instruction to stream a third type of content that is streamed on demand, from a user terminal; and
a third streaming unit that acquires the third type of content corresponding to the third instruction received by the third receiving unit, from a third storage unit in which the third type of content that is streamed on demand is stored, and streams the third type of content to the user terminal from which the third instruction was transmitted.

2. The streaming apparatus according to claim 1,
wherein the first receiving unit receives the first instruction from two or more user terminals,
the streaming apparatus further comprises a user video receiving unit that receives user videos respectively from the two or more user terminals while the first type of content is being streamed,
the first streaming unit streams, to each of the two or more user terminals, the user videos of one or more other users among the user videos received by the user video receiving unit, together with the first type of content,
the second receiving unit receives the second instruction from two or more user terminals, and
the second streaming unit does not stream user videos of one or more other users to each of the two or more user terminals.

3. The streaming apparatus according to claim 1,
wherein the second receiving unit receives the second instruction from two or more user terminals,
the streaming apparatus further comprises a user video receiving unit that receives user videos respectively from the two or more user terminals while the second type of content is being streamed, and
the second streaming unit streams, to each of the two or more user terminals, the user videos of one or more other users among the user videos received by the user video receiving unit, together with the second type of content.

4. The streaming apparatus according to claim 1, further comprising:
an input information receiving unit that receives, from each of two or more user terminals from which the first type of content, the second type of content, or the third type of content was output, input information input by users regarding the output content; and
a statistical processing unit that performs statistical processing on the input information received by the input information receiving unit, thereby acquiring statistical processing results, and outputs the statistical processing results.

5. The streaming apparatus according to claim 4,
wherein the input information is associated with a type identifier for identifying the type of the output content, and
the statistical processing unit acquires statistical processing results for each of at least three type identifiers, and outputs the statistical processing results for each type identifier.

6. The streaming apparatus according to claim 4, further comprising:
a first reservation receiving unit that receives a first reservation instruction for specifying a viewing reservation for the first type of content, from a user terminal; and
a second reservation receiving unit that receives a second reservation instruction for specifying a viewing reservation for the second type of content, from a user terminal,
wherein the statistical processing unit acquires statistical processing results regarding viewing reservations for the content, using the first reservation instruction and the second reservation instruction.

7. The streaming apparatus according to claim 4, further comprising:
a recommendation acquiring unit that acquires recommendation information on content using the statistical processing results; and
a recommendation transmitting unit that transmits the recommendation information to a user terminal.

8. The streaming apparatus according to claim 7,
wherein the recommendation acquiring unit refers to a user management unit in which one or more types of user information among viewing history information on content viewed by a user, reservation history information on content reserved for viewing by a user, and input information input by a user are stored in association with a user identifier, and acquires recommendation information on content to be viewed by a user identified with the user identifier.

9. The streaming apparatus according to claim 1, further comprising:
a communication unit that receives communication information from a user of the user terminal and transmits the communication information to the streamer terminal while the first type of content is being streamed.

10. The streaming apparatus according to claim 1, further comprising:
a screen instruction receiving unit that receives a screen instruction, which is an instruction associated with a content identifier for identifying a piece of content and is an instruction to output a first-size screen regarding the piece of content, from the user terminal;
a screen acquiring unit that acquires screen information for configuring a screen regarding the piece of content corresponding to the screen instruction from a screen storage unit in which the screen information is stored, the screen information being information for configuring the first-size screen, being information for configuring a screen regarding the piece of content, and being information for configuring a screen having a user interface component that is instructed to enable the piece of content to be viewed on a second-size screen, which is larger than the first-size screen;
a screen transmitting unit that transmits the screen information acquired by the screen acquiring unit, to the user terminal; and
a switching support unit that receives information corresponding to an instruction for the user interface component, from the user terminal, and outputs screen information for configuring the second-size screen corresponding to the information or access information for accessing the screen information.

11. A streaming method of content realized using a first receiving unit, a content receiving unit, a first streaming unit, a second receiving unit, a second streaming unit, a third receiving unit, and a third streaming unit, comprising:
a first receiving step of the first receiving unit receiving a first instruction, which is an instruction to stream a first type of content that is transmitted from a streamer terminal of the content, from a user terminal, in a time period that is specified with first streaming time information;
a content receiving step of the content receiving unit receiving the first type of content transmitted from the streamer terminal, in the time period that is specified with the first streaming time information;
a first streaming step of the first streaming unit streaming the first type of content received in the content receiving step to the user terminal from which the first instruction was transmitted, in the time period that is specified with the first streaming time information;
a second receiving step of the second receiving unit receiving a second instruction, which is an instruction to stream a second type of content that is streamed in a time period that is specified with second streaming time information, from a user terminal;
a second streaming step of the second streaming unit acquiring the second type of content corresponding to the second instruction received in the second receiving step and streaming the second type of content to the user terminal from which the second instruction was transmitted, at the time that is specified with the second streaming time information corresponding to the second type of content, the second type of content being acquired from a second storage unit in which the second type of content is stored that is associated with the second streaming time information and that is streamed to the user terminal in the time period that is specified with the second streaming time information;
a third receiving step of the third receiving unit receiving a third instruction, which is an instruction to stream a third type of content that is streamed on demand, from a user terminal; and
a third streaming step of the third streaming unit acquiring the third type of content corresponding to the third instruction received in the third receiving step, from a third storage unit in which the third type of content that is streamed on demand is stored, and streaming the third type of content to the user terminal from which the third instruction was transmitted.

12. A recording medium on which a program is recorded, the program causing a computer to function as:
a first receiving unit that receives a first instruction, which is an instruction to stream a first type of content that is transmitted from a streamer terminal of the content, from a user terminal, in a time period that is specified with first streaming time information;
a content receiving unit that receives the first type of content transmitted from the streamer terminal, in the time period that is specified with the first streaming time information;
a first streaming unit that streams the first type of content received by the content receiving unit to the user terminal from which the first instruction was transmitted, in the time period that is specified with the first streaming time information;
a second receiving unit that receives a second instruction, which is an instruction to stream a second type of content that is streamed in a time period that is specified with second streaming time information, from a user terminal;
a second streaming unit that acquires the second type of content corresponding to the second instruction received by the second receiving unit and streams the second type of content to the user terminal from which the second instruction was transmitted, at the time that is specified with the second streaming time information corresponding to the second type of content, the second type of content being acquired from a second storage unit in which the second type of content is stored that is associated with the second streaming time information and that is streamed to the user terminal in the time period that is specified with the second streaming time information;
a third receiving unit that receives a third instruction, which is an instruction to stream a third type of content that is streamed on demand, from a user terminal; and
a third streaming unit that acquires the third type of content corresponding to the third instruction received by the third receiving unit, from a third storage unit in which the third type of content that is streamed on demand is stored, and streams the third type of content to the user terminal from which the third instruction was transmitted.
